(19) United States
(12) Patent Application Publication
(10) Pub. No.: US 2025/0351154 A1
(43) Pub. Date: Nov. 13, 2025

(54) METHODS AND APPARATUSES FOR SCHEDULING MULTIPLE PHYSICAL DOWNLINK SHARED CHANNEL (PDSCH) TRANSMISSIONS

(71) Applicant: LENOVO (BEIJING) LIMITED, Beijing (CN)

(72) Inventors: Ruixiang Ma, Beijing (CN); Haipeng Lei, Beijing (CN); Yu Zhang, Beijing (CN); Haiming Wang, Beijing (CN)

(21) Appl. No.: 18/860,980

(22) PCT Filed: Apr. 29, 2022
(86) PCT No.: PCT/CN2022/090454

§ 371 Date: Oct. 28, 2024

(51) Int. Cl. H04W 72/232; H04L 1/1812; H04W 72/0446

(52) U.S. Cl. CPC H04W 72/232; H04L 1/1812; H04W 72/0446

(57) ABSTRACT

Embodiments of the present disclosure relate to methods and apparatuses for scheduling multiple physical downlink shared channel (PDSCH) transmissions. According to an embodiment of the present disclosure, a user equipment (UE) can include: a processor configured to: determine a first number of time domain resources, wherein the first number of time domain resources are used to transmit a second number of PDSCH transmissions, and the second number of PDSCH transmissions includes a third number of PDSCH transmission groups; and determine a feedback time unit to transmit hybrid automatic repeat request (HARQ) information for a PDSCH transmission group of the third number of PDSCH transmission groups; a transmitter coupled to the processor and configured to transmit the HARQ information for the PDSCH transmission group in the determined feedback time unit; and a receiver coupled to the processor.

### TECHNICAL FIELD

Embodiments of the present disclosure generally relate to wireless communication technology, and more particularly to methods and apparatuses for scheduling multiple PDSCH transmissions.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Extended reality (XR), including augmented reality (AR) and virtual reality (VR), as well as cloud gaming (CG), presents a new promising category of connected devices, applications, and services. XR applications typically require high throughput and low latency. Considering the characteristics of XR traffic, XR-specific capacity improvement is one objective in NR Rel-18. However, how to improve the capacity of XR service as well as reduce latency of the XR service has not been discussed yet.

### SUMMARY OF THE APPLICATION

Embodiments of the present application at least provide technical solutions for scheduling multiple PDSCH transmissions.

According to some embodiments of the present application, a user equipment (UE) may include: a processor configured to: determine a first number of time domain resources, wherein the first number of time domain resources are used to transmit a second number of PDSCH transmissions, and the second number of PDSCH transmissions includes a third number of PDSCH transmission groups; and determine a feedback time unit to transmit hybrid automatic repeat request (HARQ) information for a PDSCH transmission group of the third number of PDSCH transmission groups; a transmitter coupled to the processor and configured to transmit the HARQ information for the PDSCH transmission group in the determined feedback time unit; and a receiver coupled to the processor.

In some embodiments of the present application, the receiver is configured to receive downlink control information (DCI), the DCI includes a time domain resource allocation (TDRA) field which indicates a row in a table, and the row indicates one of: the first number of start and length indicators (SLIVs) or the first number of start symbol and allocation length sets; and each time domain resource of the first number of time domain resources is determined based on a corresponding SLIV of the first number of SLIVs or is determined based on a corresponding start symbol and allocation length set of the first number of start symbol and allocation length sets.

In some embodiments of the present application, the receiver is configured to receive DCI, the DCI includes a TDRA field which indicates a row in a table, and the row indicates one of: a SLIV or a start symbol and allocation length set, and herein a first time domain resource in the first number of time domain resources is determined based on the SLIV or the start symbol and allocation length set.

In some embodiments of the present application, the receiver is further configured to receive an indication indicating the first number in the DCI or in a higher layer signaling; and the processor is further configured to determine that the first number of time domain resources are contiguous in the time domain; or the processor is further configured to determine that every two time domain resources of the first number of time domain resources have a time gap between each other, the time gap is indicated by a higher layer signaling or a default value; or the processor is further configured to determine that each time domain resource of the first number of time domain resources is in a contiguous slot and a location of each time domain resource in the contiguous slot is the same.

In some embodiments of the present application, the processor is further configured to determine the first number of time domain resources until a boundary of a periodicity of semi-persistent scheduling (SPS) or until a boundary of a slot, the first number of time domain resources are contiguous in the time domain within the periodicity or the slot; or the processor is further configured to determine the first number of time domain resources until a boundary of a periodicity of SPS or until a boundary of a slot, every two time domain resources of the first number of time domain resources have a time gap between each other, and the time gap is indicated by a higher layer signaling or a default value.

In some embodiments of the present application, the first number is equal to the second number and each of the first number of time domain resources is used to transmit a corresponding PDSCH transmission of the second number of PDSCH transmissions.

In some embodiments of the present application, the processor is further configured to determine the second number of actual time domain resources based on the first number of time domain resources, each actual time domain resource of the second number of actual time domain resources is used to transmit a corresponding PDSCH transmission of the second number of PDSCH transmissions.

In some embodiments of the present application, in order to determine the second number of actual time domain resources, the processor is further configured to: determine invalid symbol(s) for PDSCH transmission in each of the first number of time domain resources, determine remaining symbol(s) other than the invalid symbol(s) in each of the first number of time domain resources to be valid symbol(s) for PDSCH transmission in each of the first number of time domain resources; in the case that the valid symbol(s) in a time domain resource is greater than zero, determine the time domain resource includes one or more actual time domain resources, each actual time domain resources includes a group of consecutive valid symbols within a slot of the time domain resource.

In some embodiments of the present application, the second number is equal to the third number and each PDSCH transmission group includes one PDSCH transmission.

In some embodiments of the present application, the third number is configured by a higher layer signaling or determined based on a number of time offset values indicated by a DCI, and the processor is further configured to: determine a number of PDSCH transmissions in each of first Q-1 PDSCH transmission groups in Q PDSCH transmission groups to be [M/Q], and a number of PDSCH transmissions in a last PDSCH transmission group in Q PDSCH transmission groups to be M-[M/Q]×(Q-1)); or determine a number of PDSCH transmissions in each of last Q-1 PDSCH transmission groups in Q PDSCH transmission groups to be [M/Q], and a number of PDSCH transmissions in a first PDSCH transmission group in Q PDSCH transmission groups to be M-[M/Q]×(Q-1)); wherein M is the second number and Q is the third number.

In some embodiments of the present application, the receiver is further configured to receive a higher layer signaling indicating a number of PDSCH transmission included in each PDSCH transmission group, the processor is further configured to determine Q=[M/P]. M is the second number, P is the number of PDSCH transmission included in each PDSCH transmission group, and Q is the third number; and the processor is further configured to: determine a number of PDSCH transmissions in each of first Q-1 PDSCH transmission groups in Q PDSCH transmission groups to be P, and a number of PDSCH transmissions in a last PDSCH transmission group in Q PDSCH transmission groups to be M-P×(Q-1)); or determine a number of PDSCH transmissions in each of last Q-1 PDSCH transmission groups in Q PDSCH transmission groups to be P, and a number of PDSCH transmissions in a first PDSCH transmission group in Q PDSCH transmission groups to be M-P×(Q-1)).

In some embodiments of the present application, the third number is configured by a higher layer signaling or determined based on a number of time offset values indicated by a DCI, and the processor is further configured to: define M₁=mod(M, Q).

$${K}_{1} = ⌈ \frac{M}{Q} ⌉ , and {K}_{2} = ⌊ \frac{M}{Q} ⌋ ,$$

wherein M is the second number and Q is the third number; in the case that M₁>0: determine that a PDSCH transmission group indexed with m includesPDSCH transmission(s) with index(es) m·K₁+k, k=0,1, . . . , K₁−1, wherein m=0,1, . . . , M₁−1; determine that a PDSCH transmission group indexed with n includes PDSCH transmission(s) with index(es) M₁·K₁+(n−M₁)·K₂+k, k=0,1, . . . , K₂−1, wherein n=M₁, M₁+1, . . . , Q−1.

In some embodiments of the present application, the receiver is further configured to receive an indication indicating a set of PDSCH group division patterns, each PDSCH group division pattern corresponds to a corresponding number of PDSCH transmissions; and the processor is further configured to determine the third number of PDSCH transmission groups based on a PDSCH group division pattern in the set of PDSCH group division patterns.

In some embodiments of the present application, in the case that the set of PDSCH group division patterns does not include a PDSCH group division pattern for the second number of PDSCH transmissions, the processor is further configured to determine the third number of PDSCH transmission groups based on a combination of PDSCH group division patterns included in the set of PDSCH group division patterns.

In some embodiments of the present application, the receiver is further configured to receive a DCI indicating a time offset value in a set of time offset value configured by a higher layer signalling or the receiver is further configured to receive a higher layer signalling indicating a time offset value; and time domain resource(s) for the PDSCH transmission group ends in a downlink (DL) time unit n_{D}, and the processor is further configured to determine the feedback time unit to transmit the HARQ information for the PDSCH transmission group to be an uplink (UL) time unit n+k, wherein n is a last UL time unit for PUCCH transmission that overlaps with n_{D}, and k is the time offset value indicated by the DCI or the higher layer signaling.

In some embodiments of the present application, the receiver is further configured to receive a DCI indicating a set of time offset values in one or more sets of time offset values configured by a higher layer signalling or the receiver is further configured to receive a higher layer signalling indicating a set of time offset values, the set of time offset values includes K time offset values.

In some embodiments of the present application, K=Q, the processor is further configured to determine that each time offset value in the K time offset value is used to determine a feedback time unit for a corresponding PDSCH transmission group in Q PDSCH transmission group, Q is the third number; or K>Q, the processor is further configured to determine that first Q time offset values in the K time offset values are used to determine feedback time unit(s) for the Q PDSCH transmission groups; or K<Q, the processor is further configured to determine that the K time offset values are cyclically used to determine feedback time unit(s) for the Q PDSCH transmission groups.

In some embodiments of the present application, time domain resource(s) for the PDSCH transmission group ends in a DL time unit n_{D}, and the processor is further configured to determine the feedback time unit to transmit the HARQ information for the PDSCH transmission group is an UL time unit n+k, wherein n is a last UL time unit for PUCCH transmission that overlaps with n_{D}, and k is a time offset value in K time offset values which corresponds to the PDSCH transmission group.

In some embodiments of the present application, each actual time domain resource is used to transmit a different transport block (TB); or actual time domain resource(s) in a time domain resource is used to transmit repetition(s) of a same TB.

In some embodiments of the present application, actual time domain resource(s) in a time domain resource is used to transmit repetition(s) of a same TB. and a TB size of the same TB is determined based on the time domain resource or determined based on an actual time domain resource in the time domain resource.

According to some other embodiments of the present application, a base station (BS) may include: a processor configured to: determine a first number of time domain resources, wherein the first number of time domain resources are used to transmit a second number of PDSCH transmissions, and the second number of PDSCH transmissions includes a third number of PDSCH transmission groups; and determine a feedback time unit to receive HARQ information for a PDSCH transmission group of the third number of PDSCH transmission groups; a receiver coupled to the processor and configured to receive the HARQ information for the PDSCH transmission group in the determined feedback time unit; and a transmitter coupled to the processor.

In some embodiments of the present application, the transmitter is configured to transmit DCI, the DCI includes a TDRA field which indicates a row in a table, and the row indicates one of: the first number of SLIVs or the first number of start symbol and allocation length sets; and each time domain resource of the first number of time domain resources is determined based on a corresponding SLIV of the first number of SLIVs or is determined based on a corresponding start symbol and allocation length set of the first number of start symbol and allocation length sets.

In some embodiments of the present application, the transmitter is configured to transmit a DCI, the DCI includes a TDRA field which indicates a row in a table, and the row indicates one of: a SLIV or a start symbol and allocation length set, and a first time domain resource in the first number of time domain resources is determined based on the SLIV or the start symbol and allocation length set.

In some embodiments of the present application, the transmitter is further configured to transmit an indication indicating the first number in the DCI or in a higher layer signaling; and the processor is further configured to determine that the first number of time domain resources are contiguous in the time domain; or the processor is further configured to determine that every two time domain resources of the first number of time domain resources have a time gap between each other, the transmitter is further configured to transmit a higher layer signaling indicating the time gap or the time gap is a default value; or the processor is further configured to determine that each time domain resource of the first number of time domain resources is in a contiguous slot and a location of each time domain resource in the contiguous slot is the same.

In some embodiments of the present application, the processor is further configured to determine the first number of time domain resources until a boundary of a periodicity of SPS or until a boundary of a slot, the first number of time domain resources are contiguous in the time domain within the periodicity or the slot; or the processor is further configured to determine the first number of time domain resources until a boundary of a periodicity of SPS or until a boundary of a slot, every two time domain resources of the first number of time domain resources have a time gap between each other, and the transmitter is further configured to transmit a higher layer signaling indicating the time gap or the time gap is a default value.

In some embodiments of the present application, the first number is equal to the second number and each of the first number of time domain resources is used to transmit a corresponding PDSCH transmission of the second number of PDSCH transmissions.

In some embodiments of the present application, the processor is further configured to determine the second number of actual time domain resources based on the first number of time domain resources, wherein each actual time domain resource of the second number of actual time domain resources is used to transmit a corresponding PDSCH transmission of the second number of PDSCH transmissions.

In some embodiments of the present application, in order to determine the second number of actual time domain resources, the processor is further configured to: determine invalid symbol(s) for PDSCH transmission in each of the first number of time domain resources, determine remaining symbol(s) other than the invalid symbol(s) in each of the first number of time domain resources to be valid symbol(s) for PDSCH transmission in each of the first number of time domain resources; in the case that the valid symbol(s) in a time domain resource is greater than zero, determine the time domain resource includes one or more actual time domain resources, wherein each actual time domain resources includes a group of consecutive valid symbols within a slot of the time domain resource.

In some embodiments of the present application, the second number is equal to the third number and each PDSCH transmission group includes one PDSCH transmission.

In some embodiments of the present application, the transmitter is further configured to transmit a higher layer signaling indicating the third number or determine the third number based on a number of time offset values indicated by a

DCI, and the processor is further configured to: determine a number of PDSCH transmissions in each of first Q-1 PDSCH transmission groups in Q PDSCH transmission groups to be [M/Q], and a number of PDSCH transmissions in a last PDSCH transmission group in Q PDSCH transmission groups to be M-[M/Q]×(Q-1)); or determine a number of PDSCH transmissions in each of last Q-1 PDSCH transmission groups in Q PDSCH transmission groups to be [M/Q], and a number of PDSCH transmissions in a first PDSCH transmission group in Q PDSCH transmission groups to be M-[M/Q]×(Q-1)); wherein M is the second number and Q is the third number.

In some embodiments of the present application, the transmitter is further configured to transmit a higher layer signaling indicating a number of PDSCH transmission included in each PDSCH transmission group, the processor is further configured to determine Q=[M/P], wherein M is the second number, P is the number of PDSCH transmission included in each PDSCH transmission group, and Q is the third number; and the processor is further configured to: determine a number of PDSCH transmissions in each of first Q-1 PDSCH transmission groups in Q PDSCH transmission groups to be P, and a number of PDSCH transmissions in a last PDSCH transmission group in Q PDSCH transmission groups to be M-P×(Q-1)); or determine a number of PDSCH transmissions in each of last Q-1 PDSCH transmission groups in Q PDSCH transmission groups to be P, and a number of PDSCH transmissions in a first PDSCH transmission group in Q PDSCH transmission groups to be M-P×(Q-1)).

In some embodiments of the present application, the transmitter is further configured to transmit a higher layer signaling indicating the third number or determine the third number based on a number of time offset values indicated by a DCI, and the processor is further configured to: define M₁=mod(M, Q),

$${K}_{1} = ⌈ \frac{M}{Q} ⌉ , and {K}_{2} = ⌊ \frac{M}{Q} ⌋ ,$$

wherein M is the second number and Q is the third number; in the case that M₁>0: determine that a PDSCH transmission group indexed with m includes PDSCH transmission(s) with index(es) m·K₁+k, k=0,1, . . . , K₁−1, wherein m=0,1, . . . , M₁−1; determine that a PDSCH transmission group indexed with n includes PDSCH transmission(s) with index(es) M₁·K₁+(n−M₁)·K₂+k, k=0,1, . . . , K₂−1, wherein n=M₁, M₁+1, . . . , Q-1.

In some embodiments of the present application, the transmitter is further configured to transmit an indication indicating a set of PDSCH group division patterns, each PDSCH group division pattern corresponds to a corresponding number of PDSCH transmissions; and the processor is further configured to determine the third number of PDSCH transmission groups based on a PDSCH group division pattern in the set of PDSCH group division patterns.

In some embodiments of the present application, in the case that the set of PDSCH group division patterns does not include a PDSCH group division pattern for the second number of PDSCH transmissions, the processor is further configured to determine the third number of PDSCH transmission groups based on a combination of PDSCH group division patterns included in the set of PDSCH group division patterns.

In some embodiments of the present application, the transmitter is further configured to transmit a DCI indicating a time offset value in a set of time offset value configured by a higher layer signalling or the transmitter is further configured to transmit a higher layer signalling indicating a time offset value; and time domain resource(s) for the PDSCH transmission group ends in a DL time unit n_{D}, and the processor is further configured to determine the feedback time unit to receive the HARQ information for the PDSCH transmission group to be an uplink (UL) time unit n+k, wherein n is a last UL time unit for PUCCH transmission that overlaps with n_{D}, and k is the time offset value indicated by the DCI or the higher layer signaling.

In some embodiments of the present application, the transmitter is further configured to transmit a DCI indicating a set of time offset values in one or more sets of time offset values configured by a higher layer signalling or the transmitter is further configured to transmit a higher layer signalling indicating a set of time offset values, the set of time offset values includes K time offset values.

In some embodiments of the present application, K=Q, the processor is further configured to determine that each time offset value in the K time offset value is used to determine a feedback time unit for a corresponding PDSCH transmission group in Q PDSCH transmission group, Q is the third number; or K>Q, the processor is further configured to determine that first Q time offset values in the K time offset values are used to determine feedback time unit(s) for the Q PDSCH transmission groups; or K<Q, the processor is further configured to determine that the K time offset values are cyclically used to determine feedback time unit(s) for the Q PDSCH transmission groups.

In some embodiments of the present application, time domain resource(s) for the PDSCH transmission group ends in a DL time unit np, and the processor is further configured to determine the feedback time unit to receive the HARQ information for the PDSCH transmission group is an UL time unit n+k, wherein n is a last UL time unit for PUCCH transmission that overlaps with n_{D}, and k is a time offset value in K time offset values which corresponds to the PDSCH transmission group.

In some embodiments of the present application, each actual time domain resource is used to transmit a different TB; or actual time domain resource(s) in a time domain resource is used to transmit repetition(s) of a same TB.

In some embodiments of the present application, actual time domain resource(s) in a time domain resource is used to transmit repetition(s) of a same TB, and a TB size of the same TB is determined based on the time domain resource or determined based on an actual time domain resource in the time domain resource.

According to some other embodiments of the present application, a method performed by a UE may include: determining a first number of time domain resources, wherein the first number of time domain resources are used to transmit a second number of PDSCH transmissions, and the second number of PDSCH transmissions includes a third number of PDSCH transmission groups; determining a feedback time unit to transmit HARQ information for a PDSCH transmission group of the third number of PDSCH transmission groups; and transmitting the HARQ information for the PDSCH transmission group in the determined feedback time unit.

According to some other embodiments of the present application, a method performed by a BS may include: determining a first number of time domain resources, wherein the first number of time domain resources are used to transmit a second number of PDSCH transmissions, and the second number of PDSCH transmissions includes a third number of PDSCH transmission groups; determining a feedback time unit to receive HARQ information for a PDSCH transmission group of the third number of PDSCH transmission groups; and receiving the HARQ information for the PDSCH transmission group in the determined feedback time unit.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary method for determining PUCCH resources for HARQ information of SPS PDSCH transmissions according to some embodiments of the present application;

FIG. 3 illustrates an exemplary method for determining a feedback time unit for multiple PDSCH transmissions according to some embodiments of the present application;

FIG. 4 is a flow chart illustrating an exemplary method for scheduling multiple PDSCH transmissions according to some embodiments of the present application;

FIG. 5 illustrates exemplary time domain resources for multiple PDSCH transmissions according to some embodiments of the present application;

FIG. 6 illustrates exemplary time domain resources for multiple PDSCH transmissions according to some other embodiments of the present application;

FIG. 7 illustrates exemplary time domain resources for multiple PDSCH transmissions according to some other embodiments of the present application;

FIG. 8 illustrates exemplary time domain resources for multiple PDSCH transmissions according to some other embodiments of the present application;

FIG. 9 illustrates exemplary time domain resources for multiple PDSCH transmissions according to some other embodiments of the present application;

FIG. 10 illustrates exemplary actual time domain resources for multiple PDSCH transmissions according to some other embodiments of the present application;

FIG. 11 illustrates an exemplary method for determining feedback time units for multiple PDSCH transmission groups according to some embodiments of the present application;

FIG. 12 illustrates another exemplary method for determining feedback time units for multiple PDSCH transmission groups according to some embodiments of the present application;

FIG. 13 illustrates another exemplary method for determining feedback time units for multiple PDSCH transmission groups according to some embodiments of the present application;

FIG. 14 is a flow chart illustrating an exemplary method for scheduling multiple PDSCH transmissions according to some embodiments of the present application; and

FIG. 15 illustrates a simplified block diagram of an exemplary apparatus for scheduling multiple PDSCH transmissions according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G (i.e., NR), 3GPP long term evolution (LTE) Release 8 and so on. Persons skilled in the art know very well that, with the development of network architecture and new service scenarios, the embodiments in the present application are also applicable to similar technical problems; and moreover, the terminologies recited in the present application may change, which should not affect the principle of the present application.

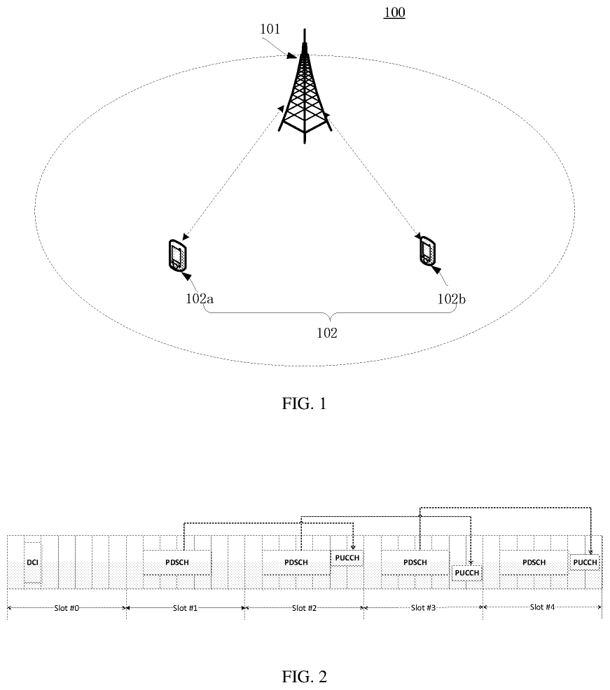

FIG. 1 is a schematic diagram illustrating an exemplary wireless communication system 100 according to some embodiments of the present application.

As shown in FIG. 1, the wireless communication system 100 includes at least one base station (BS) 101 and at least one UE 102. In particular, the wireless communication system 100 includes one BS 101 and two UEs 102 (e.g., UE 102a and UE 102b) for illustrative purposes. Although a specific number of BSs 101 and UEs 102 are depicted in FIG. 1, it is contemplated that any number of BSs 101 and UEs 102 may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a generalized node B (gNB), a home node-B, a relay node, or a device, or described using other terminology used in the art. The BS 101 is generally part of a radio access network that may include a controller communicably coupled to the BS 101.

According to some other embodiments of the present application, the UE(s) 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE(s) 102 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE(s) 102 may include wearable devices, such as smart watches, fitness bands, optical head-mounted displays, or the like.

Moreover, the UE(s) 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

According to some embodiments of the present application, the UE(s) 102 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102a may be a power-saving UE and the UE 102b may be a VUE. In another embodiment of the present application, both the UE 102a and the UE 102b may be VUEs or power-saving UEs.

Both the UE 102a and the UE 102b in the embodiments of FIG. 1 are in a coverage area of the BS 101, and may transmit information or data to the BS 101 and receive control information or data from the BS 101, for example, via an LTE or NR Uu interface. In other embodiments, one or more of the UE 102a and the UE 102b may be outside of the coverage area of the BS 101. The UE 102a and the UE 102b may communicate with each other via sidelink.

In some embodiments, a UE (e.g., UE 102a or UE 102b) may receive a DCI format scheduling a number of PDSCH receptions (in other words, PDSCH transmissions) which may end in a DL slot n_{D}. Then, the UE may provide HARQ information (e.g., acknowledgement (ACK) or negative acknowledgement (NACK)) for the number of PDSCH receptions in a physical uplink control channel (PUCCH) transmission within an UL slot n+k, where n is a last UL slot for PUCCH transmission that overlaps with slot n_{D} and k is a time offset value (e.g., a number of slots). In an embodiment, k may be indicated by the DCI format. In such embodiment, a PDSCH-to-HARQ feedback timing indicator field in the DCI format may indicate a time offset value in a set of time offset values configured by an RRC signalling from the BS, then k may be the time offset value indicated by the PDSCH-to-HARQ feedback timing indicator field in the DCI format. In another embodiment, the UE may receive an RRC signalling indicating one time offset value, then k may be the one time offset value configured by the RRC signalling.

In some other embodiments, the UE may receive an activating DCI which activates an SPS configuration from one or more SPS configurations, wherein each of the one or more SPS configurations may include a period P and a parameter nlPUCCH-AN as specified in 3GPP standard documents for the SPS configuration. In addition, the activating DCI may also indicate the time domain resource and frequency domain resource of the PDSCH for the activated SPS configuration, and indicate a time offset value K1 (e.g., a number of slots) for determining a slot for a PUCCH transmission. In such embodiments, when it is assumed that a number of PDSCH receptions based on an activated SPS configuration ends in a DL slot n_{D}, then the UE may provide HARQ information for the number of PDSCH receptions in a PUCCH transmission within an UL slot n+K1, where n is a last UL slot for PUCCH transmission that overlaps with slot n_{D}.

FIG. 2 illustrates an exemplary method for determining PUCCH resources for HARQ information of SPS PDSCH transmissions according to some embodiments of the present application.

In the example of FIG. 2, it is assumed that there are four SPS configurations with indexes #0 to #3, respectively. A UE may receive a DCI in slot #0, which activates SPS configuration #1. The period P for SPS configuration #1 is one slot. In addition, the DCI may also indicate the time domain resource and frequency domain resource of PDSCH transmission for the activated SPS configuration #1, as shown in FIG. 2. Given this, there is one SPS PDSCH reception per slot. For simplicity, the example in FIG. 2 only illustrates three slots (e.g., slot #1, slot #2, and slot #3), wherein each slot includes an SPS PDSCH reception. In addition, when it is assumed that the DCI indicates a time offset value K1=1 slot, then HARQ information for a corresponding SPS PDSCH reception may be in a PUCCH transmission within the next slot of the corresponding SPS PDSCH reception. For example, for SPS PDSCH reception in slot #1, the HARQ information may be in a PUCCH transmission within slot #2.

XR, including AR and VR, as well as CG, presents a new promising category of connected devices, applications, and services. XR applications typically require high throughput and low latency, and have big and variable data packet sizes. Considering the characteristics of XR traffic, XR-specific capacity improvement is one objective in NR Rel-18.

Using one DCI to schedule multiple PDSCH resources to transmit multiple TBs may be a method to improve XR traffic capacity. For example, only one DCI is transmitted to schedule multiple TBs, such that overhead and latency may also be reduced.

However, using one DCI to schedule multiple TB has problems. Specifically, as stated above, if the UE detects a DCI format scheduling a number of PDSCH transmissions which end in DL slot n_{D}, then the UE may provide corresponding HARQ information in a PUCCH transmission within a UL slot n+k, which means that the feedback time unit for all of the number of PDSCH transmissions is the same and may be calculated from the last PDSCH transmission of the number of PDSCH transmissions. In such cases, if a TB in any PDSCH transmission before the last PDSCH transmission is not correctly received by the UE, the UE cannot feed back any NACK to the BS to ask for the transmission of the TB because it should wait for the last PDSCH transmission, which would cause unnecessary latency.

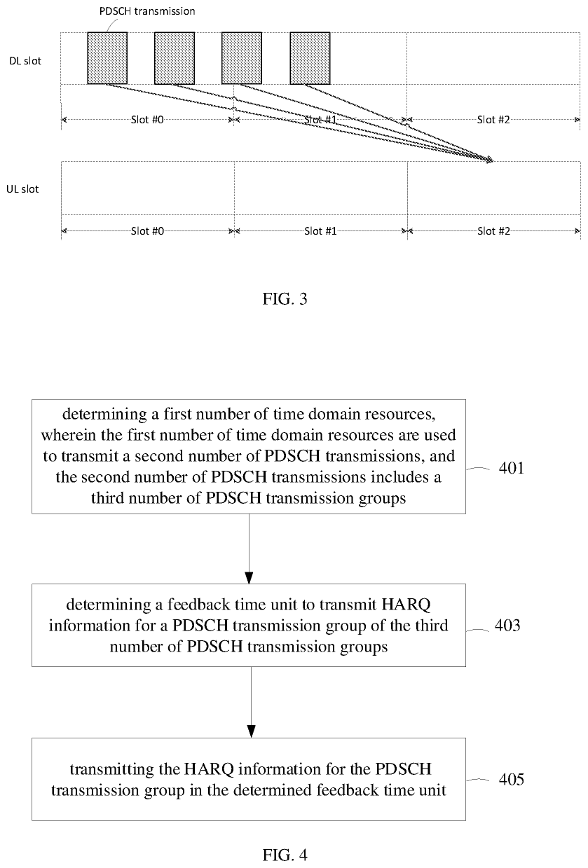

FIG. 3 illustrates an exemplary method for determining feedback time units for multiple PDSCH transmissions according to some embodiments of the present application.

In the example of FIG. 3, it is assumed that a UE receives a DCI format scheduling 4 PDSCH transmissions ending in a DL slot #2. Moreover, it is also assumed that a time offset value (e.g., k) for determining a feedback time unit as stated above is 1 slot. Then, the UE may provide corresponding HARQ information for the 4 PDSCH transmissions in a PUCCH transmission in an UL slot #3, which may bring large feedback latency, especially for the first one or two PDSCH transmissions. The example in FIG. 3 is only for illustrative purpose, and persons skilled in the art can understand that feedback latency may be increased as the number of PDSCH transmissions increases.

Accordingly, solutions regarding how to reduce feedback latency for multiple PDSCH transmissions are needed.

Given the above, embodiments of the present application propose solutions for scheduling multiple PDSCH transmissions, which can reduce feedback latency for multiple PDSCH transmissions. The solutions of the subject application can be used for XR service and any other cases in which one DCI schedules or activates multiple PDSCH transmissions. More details on embodiments of the present application will be illustrated in the following text in combination with the appended drawings.

FIG. 4 is a flow chart illustrating an exemplary method for scheduling multiple PDSCH transmissions according to some embodiments of the present application. The method in FIG. 4 may be implemented by a UE (e.g., UE 102a or UE 102b as shown in FIG. 1).

In the exemplary method shown in FIG. 4, in step 401, the UE may determine a first number (e.g., N) of time domain resources. The first number of time domain resources may be used to transmit a second number (e.g., M) of PDSCH transmissions.

In some embodiments of the present application, the UE may receive DCI, and the N time domain resources may be determined based on the DCI.

Specifically, the DCI may include a TDRA field which indicates a row in a table (e.g., a TDRA table). For example, the value of the TDRA field being “m” may indicate a row indexed with “m+1” in the table.

In an embodiment, the table may be configured by the BS via a higher layer signaling (e.g., RRC signaling), for example, the table may be configured by the parameter “pdsch-TimeDomainAllocationListForMultiPDSCH-r17” as specified in 3GPP standard documents. In another embodiment, the table may be pre-defined (e.g., fixed in 3GPP standard documents). The table may include one or more rows (i.e., entries). Each of the one or more rows may indicate: multiple SLIVs or multiple start symbol and allocation length sets (each set may include a start symbol and an allocation length).

In such embodiments, the row indicated by the TDRA field may indicate multiple SLIVs or multiple start symbol and allocation length sets, wherein each SLIV or each start symbol and allocation length set may be used by the UE to determine a corresponding time domain resource.

Consequently, in such embodiments, the UE may determine N time domain resources, wherein N is equal to a number of SLIVs or a number of start symbol and allocation length sets indicated by the row. Each time domain resource of the N time domain resources is determined based on a corresponding SLIV of the multiple SLIVs or is determined based on a corresponding start symbol and allocation length set of multiple start symbol and allocation length sets indicated by the row.

For example, when it is assumed that the row indicates 5 SLIVs, then in step 501, the UE may determine 5 time domain resources, wherein each resource may be determined based on a corresponding SLIV in the 5 SLIVs.

In some other embodiments of the present application, the UE may receive DCI, and a first time domain resource of the N time domain resources may be determined based on the DCI.

Specifically, the DCI may include a TDRA field which indicates a row in a table (e.g., a TDRA table). For example, the value of the TDRA field being “m” may indicate a row indexed with “m+1” in the table.

In an embodiment, the table may be configured by the BS via a higher layer signaling (e.g., an RRC signaling). In another embodiment, the table may be pre-defined (e.g., fixed in 3GPP standard documents). The table may include one or more rows (i.e., entries). Each of the one or more rows may indicate: a slot offset K₀ as specified in 3GPP standard documents, an SLIV or a start symbol and allocation length set (the set may include a start symbol and an allocation length), and a PDSCH mapping type to be assumed in the PDSCH transmission.

In such embodiments, the row indicated by the TDRA field may indicate an SLIV or a start symbol and allocation length set. In such embodiments, the UE may determine a time domain resource based on the SLIV or start symbol and allocation length set indicated by the row. The determined time domain resource may be a first time domain resource in the N time domain resources. The remaining time domain resource may be determined by the following solutions.

### Solution 1

In solution 1, the UE may receive an indication indicating the number “N” in the DCI or in a higher layer (e.g., a layer higher than a physical layer) signaling, e.g., RRC signaling. Specifically, the indication may indicate the number “N” by the following two alternatives.

In one alternative, the indication may directly indicate the number “N.”

In another alternative, a repetition number may be used as the number “N” and the UE determines how to understand the repetition number based on the indication as stated above. That is, the the indication may indicate whether the repetition number can be used as the number “N.” For example, the indication with value “1” may indicate that the repetition number is used as the number “N,” but not used for repetition number indication, whereas the indication with value “0” may indicate that the repetition number is not used as the number “N,” but is used for repetition number indication, and vice versa.

In solution 1, the N time domain resources are contiguous in the time domain. Accordingly, after determining the first time domain resource in the N time domain resources as stated above, the UE may determine the remaining time domain resources, wherein each remaining time domain resource may have the same time duration (e.g., including the same number of symbols) as the first time domain resource.

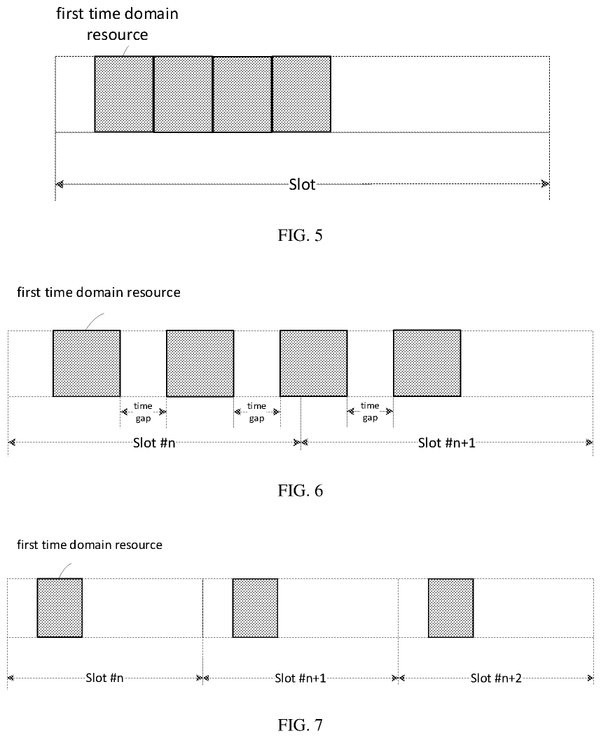

FIG. 5 illustrates exemplary time domain resources for multiple PDSCH transmissions according to some embodiments of the present application.

Referring to FIG. 5, it is assumed that N=4. Then, after determining the first time domain resource as stated above, the UE may determine the remaining 3 time domain resources, wherein each remaining time domain resource includes the same number of symbols as the first time domain resource, and the 4 time domain resources are contiguous in the time domain.

### Solution 2

In solution 2, the UE may receive an indication indicating the number “N” in the DCI or in a higher layer (e.g., a layer higher than a physical layer) signaling, e.g., RRC signaling. The indication may be the same as that in solution 1.

In solution 2, every two time domain resources of the time domain resources have a time gap between each other. In some embodiments, the UE may receive a higher layer signaling indicating the time gap. In some other embodiments, the time gap may be a default value. The time gap may be a time duration or a number of time units. In an embodiment, the time unit may be a symbol, slot, etc. For example, the time gap may be a number of symbols.

Accordingly, after determining the first time domain resource in the N time domain resources as stated above, the UE may determine the remaining time domain resources based on the first time domain resource and the time gap. In some cases, the time gap may be used for determining the start point of each remaining time domain resource, for example, a start symbol of a next time domain resource may be equal to an end symbol of the preceding time domain resource plus the time gap. In solution 2, each remaining time domain resource may have the same time duration (e.g., including the same number of symbols) as the first time domain resource.

FIG. 6 illustrates exemplary time domain resources for multiple PDSCH transmissions according to some embodiments of the present application.

Referring to FIG. 6, it is assumed that N=4 and there is a time gap between every two time domain resources. Then, after determining the first time domain resource as stated above, the UE may determine the remaining 3 time domain resources based on the first time domain resource and the time gap. For example, the start symbol of a next time domain resource may be equal to the end symbol of the preceding time domain resource plus the time gap. In addition, each remaining time domain resource includes the same number of symbols as the first time domain resource.

### Solution 3

In solution 3, the UE may receive an indication indicating the number “N” in the DCI or in a higher layer (e.g., a layer higher than a physical layer) signaling, e.g., an RRC signaling. The indication may be the same as that in solution 1.

In solution 3, the N time domain resource is in N contiguous slots, wherein each time domain resource is in a corresponding contiguous slot of the N contiguous slots, and a location of each time domain resource in the corresponding contiguous slot is the same. For example, the location of a time domain resource may refer to the start symbol and the time duration (e.g., including the same number of symbols) of the time domain resource.

Accordingly, after determining the first time domain resource which is in a slot, the UE may determine N-1 slots consecutive to the slot. Then, in each slot of the N-1 slots, the UE may determine a corresponding time domain resource. The corresponding time domain resource in each slot may have the same location (e.g., the start symbol and the time duration) as the first time domain resource.

FIG. 7 illustrates exemplary time domain resources for multiple PDSCH transmissions according to some embodiments of the present application.

Referring to FIG. 7, it is assumed that N=3. Then, after determining the first time domain resource which is in a slot (e.g., slot #n) as stated above, the UE may determine the remaining 2 time domain resources in slot #n+1 and slot #n+2. Specifically, the start symbol and the time duration of each remaining time domain resource may be the same as the first time domain resource.

### Solution 4

In solution 4, the BS may not indicate the number “N” to the UE. Instead, the UE may determine one or more time domain resources until a boundary of a periodicity of SPS or until a boundary of a slot, wherein the one or more time domain resources are contiguous in the time domain within the periodicity or the slot. Then, the one or more time domain resources determined by the UE may be the N time domain resources.

Specifically, after determining the first time domain resource which is in a periodicity of SPS or in a slot a as stated above, the UE may determine zero or more remaining time domain resources consecutive to the first time domain resource until a boundary of the periodicity of SPS or until a boundary of the slot, wherein each remaining time domain resource may have the same time duration (e.g., including the same number of symbols) as the first time domain resource. The determined remaining time domain resources and the first time domain resource are the N time domain resources.

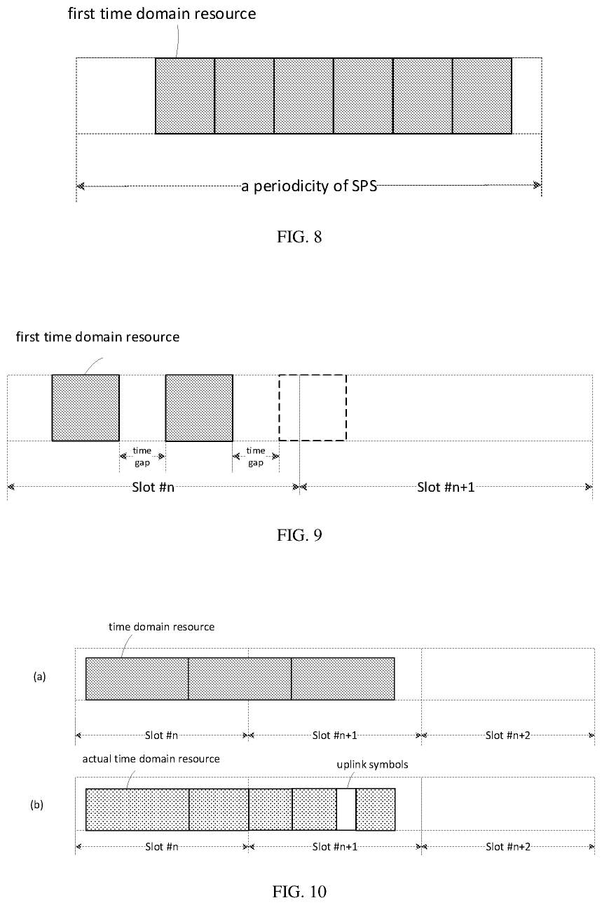

FIG. 8 illustrates exemplary time domain resources for multiple PDSCH transmissions according to some embodiments of the present application.

Referring to FIG. 8, after determining the first time domain resource which is in a periodicity of SPS as stated above, the UE may determine the remaining contiguous time domain resources until a boundary of the periodicity of SPS, wherein each remaining time domain resource includes the same number of symbols as the first time domain resource. As shown in FIG. 8, only 6 time domain resources can be determined because the seventh time domain resource would cross the boundary of the periodicity of SPS. Consequently, the N time domain resources include 6 time domain resources.

### Solution 5

In solution 5, the BS may not indicate the number “N” to the UE. Instead, the UE may determine one or more time domain resources until a boundary of a periodicity of SPS or until a boundary of a slot, wherein every two time domain resources of the first number of time domain resources have a time gap between each other. Then, the one or more time domain resources determined by the UE may be the N time domain resources.

In some embodiments, the UE may receive a higher layer signaling indicating the time gap. In some other embodiments, the time gap may be a default value. The time gap may be a time duration or a number of time units. In an embodiment, the time unit may be a symbol, slot, etc. For example, the time gap may be a number of symbols.

Accordingly, after determining the first time domain resource which is in a periodicity of SRS or a slot as stated above, the UE may determine the remaining time domain resources based on the first time domain resource and the time gap until a boundary of the periodicity of SPS or until a boundary of the slot. In some cases, the time gap may be used for determining the start point of each remaining time domain resource, for example, a start symbol of a next time domain resource may be equal to an end symbol of the preceding time domain resource plus the time gap. In solution 5, each remaining time domain resource may have the same time duration (e.g., including the same number of symbols) as the first time domain resource.

FIG. 9 illustrates exemplary time domain resources for multiple PDSCH transmissions according to some embodiments of the present application.

Referring to FIG. 9, it is assumed that there is a time gap between every two time domain resources. Then, after determining the first time domain resource which is in a slot (e.g., slot #n) as stated above, the UE may determine the remaining time domain resources based on the first time domain resource and the time gap until a boundary of the slot. For example, the start symbol of a next time domain resource may be equal to the end symbol of the preceding time domain resource plus the time gap. In addition, each remaining time domain resource includes the same number of symbols as the first time domain resource. As shown in FIG. 9, only 2 time domain resources may be determined because the third time domain resource would cross the boundary of the slot. Consequently, the N time domain resources include 2 time domain resources.

As stated above, the N time domain resources may be used to transmit M PDSCH transmission.

According to some embodiments of the present application, M=N. That is, each of the N time domain resources is used to transmit a corresponding PDSCH transmission of N PDSCH transmissions. In such embodiments, each PDSCH transmission may include a different TB.

According to some other embodiments of the present application, the UE may determine M actual time domain resources based on the N time domain resources, wherein each actual time domain resource of the M actual time domain resources is used to transmit a corresponding PDSCH transmission of the N PDSCH transmissions. In such embodiments, the N time domain resources may also referred to as N nominal time domain resources.

In some embodiments, in order to determine the M actual time domain resources, the UE may first determine invalid symbol(s) for PDSCH transmission in each time domain resource of N time domain resources. The following embodiments may illustrate how to determine the invalid symbol(s).

In an embodiment, the UE may receive a parameter (e.g., a parameter tdd-UL-DL-ConfigurationCommon as specified in 3GPP standard documents or a parameter tdd-UL-DL-ConfigurationDedicated as specified in 3GPP standard documents) indicating which symbol(s) is uplink symbol(s). A symbol that is indicated as an uplink symbol is determined as an invalid symbol for PDSCH transmission by the UE.

Alternatively or additionally, the UE may receive a higher layer parameter indicating invalid symbol(s) from the BS. For example, the UE may receive a higher layer parameter invalidSymbolPattern as specified in 3GPP standard documents.

In some embodiments, the higher layer parameter invalidSymbolPattern may include a higher layer parameter symbols, which provides a symbol level bitmap spanning one or two slots. For example, a bit value equal to 1 in the symbol level bitmap indicates that a corresponding symbol is an invalid symbol for PDSCH transmission, and a bit value equal to 0 in the symbol level bitmap indicates that a corresponding symbol is an valid symbol for PDSCH transmission.

In some embodiments, the higher layer parameter invalidSymbolPattern may also include a higher layer parameter periodicityAndPattern, wherein each bit of periodicityAndPattern corresponds to a unit equal to a duration (e.g., one slot or two slots as stated above) of the symbol level bitmap. For example, a bit value equal to 1 indicates that the symbol level bitmap is present in the unit. The periodicityAndPattern may be {1, 2, 4, 5, 8, 10, 20 or 40} units long, but the maximum length of the periodicityAndPattern is 40 ms. The first symbol of periodicityAndPattern every (40 msec/P) periods is a first symbol in a frame n_{f} which mod 4=0, wherein P is the duration of periodicityAndPattern and in units of ms.

In some other embodiments, the higher layer parameter invalidSymbolPattern may not include the higher layer parameter periodicityAndPattern (i.e., the periodicityAndPattern is not configured). Then, for a symbol level bitmap spanning two slots, the bits of the first and second slots respectively correspond to even and odd slots of a radio frame; for a symbol level bitmap spanning one slot, the bits of the one slot correspond to every slot of a radio frame.

In some embodiments, if the higher layer parameter invalidSymbolPattern is configured by the BS, when the UE applies an invalid symbol pattern is determined as follows:
if the PDSCH is scheduled by DCI format 1_1, or corresponds to an SPS PDSCH activated by DCI format 1_1, and if invalidSymbolPatternIndicatorDCI-1-1 is configured,
   if invalid symbol pattern indicator field is set 1, the UE applies the invalid symbol pattern;
   otherwise, the UE does not apply the invalid symbol pattern;
if the PDSCH is scheduled by DCI format 1_2, or corresponds to an SPS PDSCH activated by DCI format 1_2, and if invalidSymbolPatternIndicatorDCI-1-2 is configured,
   if invalid symbol pattern indicator field is set 1, the UE applies the invalid symbol pattern;
   otherwise, the UE does not apply the invalid symbol pattern;
otherwise, the UE applies the invalid symbol pattern.

Accordingly, based on the higher layer parameter invalidSymbolPattern as stated above, the UE may determine invalid symbol(s) for PDSCH transmission in each time domain resources.

After determining the invalid symbol(s) for PDSCH transmission in each of the N time domain recourses, the UE may determine remaining symbol(s) other than the invalid symbol(s) in each of the N time domain resources to be valid symbol(s) for PDSCH transmission in each of the N time domain resources.

In the case that the valid symbol(s) in a time domain resource of the N time domain resources is greater than zero, the UE may determine that the time domain resource includes one or more actual time domain resources, wherein each actual time domain resources includes a group of consecutive valid symbols within a slot of the time domain resource. Consequently, the UE may determine M actual time domain resources based on the N time domain resources. The M actual time domain resources may be used to transmit M PDSCH transmissions, wherein each actual time domain resource may be used to transmit a corresponding PDSCH transmission.

In some embodiments, each actual time domain resource is used to transmit a different TB. That is, each PDSCH transmission of the M PDSCH transmissions includes a different TB.

In some other embodiments, the actual time domain resource(s) in a time domain resource is used to transmit repetition(s) of a same TB. For example, assuming that one time domain resource includes five actual time domain resources, then, each of the actual time domain resources is used to transmit a repetition of a same TB.

In some other embodiments, an actual time domain resource(s) in a time domain resource is used to transmit repetition(s) of a same TB, and a TB size of the same TB is determined based on the time domain resource or determined based on an actual time domain resource in the time domain resource.

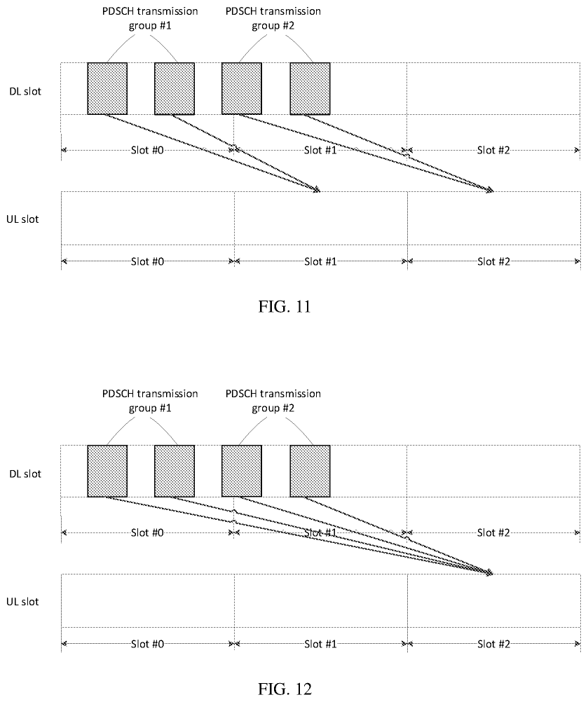

FIG. 10 illustrates exemplary actual time domain resources for multiple PDSCH transmissions according to some other embodiments of the present application.

Referring to sub-figure (a) in FIG. 10, it is assumed that the UE determines 3 time domain resources by using the method as stated above. For the third time domain resource, there are some uplink symbols as shown in sub-figure (b) in FIG. 10.

Accordingly, referring to sub-figure (a) in FIG. 10, the first time domain resource consists of 1 actual time domain resource. The second time domain resource consists of 2 actual time domain resources, one is in slot #n and the other one is in the slot #n+1. The third time domain resource consists of 2 actual time domain resources. Accordingly, the 3 time domain resources include 5 actual time domain resources. Each actual time domain resource may be used to transmit a PDSCH transmission.

In some embodiments, each actual time domain resource may be used to transmit a different TB. Accordingly, UE may receive 5 TBs.

In some embodiments, the actual time domain resources in a same time domain resource may be used to transmit repetitions of a same TB. Accordingly, UE may receive 3 TBs. The 2 actual time domain resources in the second time domain resource may be used to transmit two repetitions of a TB, and the 2 actual time domain resources in the third time domain resource may be used to transmit two repetitions of another TB.

According to some embodiments of the present application, in order to reduce feedback latency, the M PDSCH transmissions may be divided into Q PDSCH transmission groups.

In some embodiments of the present application, M=Q. That is, each PDSCH transmission group may include one PDSCH transmission of the M PDSCH transmissions.

In some other embodiments, the UE may determine the Q PDSCH transmission groups based on one of the following solutions.

### Solution I

In solution I, the number Q may be indicated by the BS. Specifically, in some embodiments, the UE may receive a higher layer signaling indicating the number Q. In some other embodiments, the DCI received by the UE as stated above may indicate a number of time offset values for determining feedback time unit(s) (which will be illustrated below), then, the UE may determine Q based on the number of time offset values, for example, the UE may determine Q to be equal to the number of time offset values.

After receiving the number Q, in some embodiments, the UE may determine a number of PDSCH transmissions in each of first Q-1 PDSCH transmission groups in Q PDSCH transmission groups to be [M/Q], and a number of PDSCH transmissions in a last PDSCH transmission group in Q PDSCH transmission groups to be M-[M/Q]×(Q-1).

In some other embodiments, the UE may determine a number of PDSCH transmissions in each of last Q-1 PDSCH transmission groups in Q PDSCH transmission groups to be [M/Q], and a number of PDSCH transmissions in a first PDSCH transmission group in Q PDSCH transmission groups to be M-[M/Q]×(Q-1).

For example, when it is assumed that M=8 and Q=3, then, each of the first 2 PDSCH transmission groups may include 2 PDSCH transmissions and the last PDSCH transmission group may include could 4 PDSCH transmissions.

### Solution II

In solution II, the UE may receive a higher layer signaling indicating a number of PDSCH transmission (e.g., P) included in each PDSCH transmission group. Then, the UE may determine Q=[M/P].

In some embodiments, the UE may determine a number of PDSCH transmissions in each of first Q-1 PDSCH transmission groups in Q PDSCH transmission groups to be P, and a number of PDSCH transmissions in a last PDSCH transmission group in Q PDSCH transmission groups to be M-P×(Q-1).

In some other embodiments, the UE may determine a number of PDSCH transmissions in each of last Q-1 PDSCH transmission groups in Q PDSCH transmission groups to be P, and a number of PDSCH transmissions in a first PDSCH transmission group in Q PDSCH transmission groups to be M-P×(Q-1).

For example, when it is assumed that M=8 and P=3, then, the UE may determine that Q=[8/3]=3. Then, the UE may determine that each of the first 2 PDSCH transmission groups includes 3 PDSCH transmissions and the last PDSCH transmission group includes 2PDSCH transmissions.

### Solution III

In solution III, the number Q may be indicated by the BS, which is the same as solution I. The UE may define M₁=mod(M, Q),

$${K}_{1} = ⌈ \frac{M}{Q} ⌉ , and {K}_{2} = ⌊ \frac{M}{Q} ⌋ .$$

In the case that M₁>0, the UE may determine that a PDSCH transmission group indexed with m includes PDSCH transmission(s) with index(es) m·K₁+k, k=0,1, . . . , K₁−1, wherein m=0,1, . . . , M₁−1; and determine that a PDSCH transmission group indexed with n includes PDSCH transmission(s) with index(es) M₁·K₁+(n-M₁)·K₂+k, k=0,1, . . . , K₂−1, wherein n=M₁, M₁+1, . . . , Q-1.

For example, when it is assumed that M=8 and Q=3, then, the UE may define M₁=mod(8,3)=2,

$${K}_{1} = ⌈ \frac{8}{3} ⌉ = 3 , and {K}_{2} = ⌊ \frac{8}{3} ⌋ = 2.$$

Since M₁>0, for a PDSCH transmission group indexed with m (wherein m=0,1), the UE may determine it includes PDSCH transmissions with indexes m·3+k, k=0,1, . . . ,2. That is, for a first PDSCH transmission group (e.g., PDSCH transmission group indexed with 0), it may include PDSCH transmissions with indexes 0, 1, 2; and for a second PDSCH transmission group (e.g., PDSCH transmission group indexed with 1), it may include PDSCH transmissions with indexes 3, 4, 5.

For a PDSCH transmission group indexed with n (wherein n=2), the UE may determine it includes PDSCH transmissions with indexes 2·3+(n−2)·3+k,k=0,1. That is, for a third PDSCH transmission group (e.g., PDSCH transmission group indexed with 2), it may include PDSCH transmissions with indexes 6 and 7.

### Solution IV

In solution IV, the UE may receive an indication indicating a set of PDSCH group division patterns in a higher layer signalling from the BS, wherein each PDSCH group division pattern may correspond to a number of PDSCH transmissions. Then, the UE may determine the Q PDSCH transmission groups based on a PDSCH group division pattern in the set of PDSCH group division patterns.

For example, in the case that the set of PDSCH group division patterns includes a PDSCH group division pattern for the M PDSCH transmissions, the UE may determine the Q PDSCH transmission groups based on the PDSCH group division pattern.

In the case that the set of PDSCH group division patterns does not include a PDSCH group division pattern for the M PDSCH transmissions, the UE may determine the Q PDSCH transmission groups based on a combination of PDSCH group division patterns included in the set of PDSCH group division patterns.

For example, it is assumed that the set of PDSCH group division patterns includes a PDSCH group division pattern {2,2} corresponding to 4 PDSCH transmissions and a PDSCH group division pattern {2,1} corresponding to 3 PDSCH transmissions. Then, in the case that M=4, the UE may determine Q=2 and each PDSCH transmission group includes two PDSCH transmissions; in the case that M=3, the UE may determine Q=2, and the first PDSCH transmission group includes two PDSCH transmissions and the second PDSCH transmission group includes one PDSCH transmission; and in the case that M=7, since the set of PDSCH group division patterns does not include a PDSCH group division pattern corresponding to 7 PDSCH transmissions, the UE may determine a PDSCH group division pattern corresponding to 7 PDSCH transmissions to be {2.2.1.2}, which is a combination of the above two PDSCH group division patterns {2,2} and {2,1}. That is, Q=4, and the numbers of the PDSCH transmission in the 4 PDSCH transmission groups are 2, 2, 1, 2, respectively.

After determining the Q PDSCH transmission groups, in step 403, for each PDSCH transmission group, the UE may determine a feedback time unit to transmit the HARQ information for a corresponding PDSCH transmission group.

For simplicity, embodiments of FIG. 4 only take a PDSCH transmission group (e.g., PDSCH transmission group #G1) as an example, the exemplary PDSCH transmission group #G1 in FIG. 4 may be any PDSCH transmission group in the Q PDSCH transmission groups, and the method for determining a feedback time unit to transmit HARQ information for the PDSCH transmission group #G1 may also be used to determine a feedback time unit for other PDSCH transmission group in the Q PDSCH transmission groups.

Specifically, in the case that time domain resource(s) for the PDSCH transmission group #G1 ends in a DL time unit n_{D}, the UE may determine the feedback time unit to transmit the HARQ information for the PDSCH transmission group #G1 to be an UL time unit n+k, wherein n is a last UL time unit for PUCCH transmission that overlaps with n_{D}, and k is a time offset value.

In some embodiments, the time unit (e.g., the DL time unit, UL time unit, or the feedback time unit) as stated above may be a slot, a sub-slot, a symbol, or any other time unit. In some embodiments, the time offset value may be in units of a slot, sub-slot, symbol, or any other time unit. For example, the time unit may be a slot and the time offset value may be a number of slots.

The time offset value k may be determined based on one of the following methods.

### Method 1

In method 1, k may be indicated by the DCI or a higher layer signalling from the BS.

Specifically, in some embodiments, the DCI received by the UE as stated above may indicate a time offset value k in a set of time offset values. The set of time offset values may be configured by the BS via a higher layer signalling.

In some other embodiments, the UE may receive a higher layer signalling indicating a time offset value k from the BS.

Then, after receiving the time offset value k, the UE may determine that it will be used for all the Q PDSCH transmission groups to determine the feedback time units. That is, the UE may use a same time offset value k to determine the feedback time unit for each of the Q PDSCH transmission groups.

FIG. 11 illustrates an exemplary method for determining feedback time units for multiple PDSCH transmission groups according to some embodiments of the present application.

In the example of FIG. 11, it is assumed that a UE receives a DCI scheduling 4 PDSCH transmissions, and the 4 PDSCH transmissions are included in two PDSCH transmission groups (e.g., PDSCH transmission group #1 and PDSCH transmission group #2). Moreover, it is also assumed that a time offset value k for determining a feedback time unit as stated above is 1 slot. Then, for PDSCH transmission group #1 which ends in DL slot #0, the UE may determine a feedback time unit to transmit the HARQ information for the PDSCH transmission group #1 is slot #1; and for PDSCH transmission group #2 which ends in DL slot #1, the UE may determine a feedback time unit to transmit the HARQ information for the PDSCH transmission group #2 is slot #2.

### Method 2

In method 2, the UE may receive a set of time offset values via the DCI or via a higher layer signalling from the BS.

Specifically, in some embodiments, the DCI received by the UE as stated above may indicate a set of time offset values in one or more sets of time offset values. The one or more sets of time offset values may be configured by a higher layer signalling from the BS.

In some other embodiments, the UE may receive a higher layer signalling indicating a set of time offset values.

The set of time offset values indicated by the DCI or the higher layer signalling may include K time offset values.

In such embodiments, the time offset value k may be a time offset value in the K time offset values which corresponds to the PDSCH transmission group #G1.

Specifically, in some embodiments, K=Q. That is, each time offset value in the set of time offset values may correspond to a PDSCH transmission group of the Q PDSCH transmission groups. In such embodiments, the UE may determine that each time offset value in the K time offset value is used to determine a feedback time unit for a corresponding PDSCH transmission group in the Q PDSCH transmission group.

FIG. 12 illustrates another exemplary method for determining feedback time units for multiple PDSCH transmission groups according to some embodiments of the present application.

In the example of FIG. 12, it is assumed that a UE receives a DCI scheduling 4 PDSCH transmissions, and the 4 PDSCH transmissions are included in two PDSCH transmission groups (e.g., PDSCH transmission group #1 and PDSCH transmission group #2). Moreover, it is also assumed that the set of time offset values indicated by the DCI or a higher layer signaling is {2,1}. Then, the UE may determine that the time offset value being 2 slots is used for PDSCH transmission group #1 and the time offset value being 1 slot is used for PDSCH transmission group #2.

Then, for PDSCH transmission group #1 which ends in DL slot #0, the UE may determine a feedback time unit to transmit the HARQ information for the PDSCH transmission group #1 is slot #2; and for PDSCH transmission group #2 which ends in DL slot #1, the UE may determine a feedback time unit to transmit the HARQ information for the PDSCH transmission group #2 is slot #2.

In some other embodiments, K=Q. That is, each time offset value in the set of time offset values may correspond to a PDSCH transmission group of the Q PDSCH transmission groups. In such embodiments, the UE may determine that each time offset value in the K time offset value is used to determine a feedback time unit for a corresponding PDSCH transmission group in the Q PDSCH transmission group.

FIG. 12 illustrates another exemplary method for determining feedback time units for multiple PDSCH transmission groups according to some embodiments of the present application.

In the example of FIG. 12, it is assumed that a UE receives a DCI scheduling 4 PDSCH transmissions, and the 4 PDSCH transmissions are included in two PDSCH transmission groups (e.g., PDSCH transmission group #1 and PDSCH transmission group #2). Moreover, it is also assumed that the set of time offset values indicated by the DCI or a higher layer signaling is {2.1}. Then, the UE may determine that the time offset value being 2 slots is used for PDSCH transmission group #1 and the time offset value being 1 slot is used for PDSCH transmission group #2.

Then, for PDSCH transmission group #1 which ends in DL slot #0, the UE may determine a feedback time unit to transmit the HARQ information for the PDSCH transmission group #1 is slot #2; and for PDSCH transmission group #2 which ends in DL slot #1, the UE may determine a feedback time unit to transmit the HARQ information for the PDSCH transmission group #2 is slot #2.

In some other embodiments, K>Q. The UE may determine that first Q time offset values in the K time offset values are used to determine feedback time unit(s) for the Q PDSCH transmission groups. That is, each time offset value in the first Q time offset values may correspond to a PDSCH transmission group of the Q PDSCH transmission groups. In such embodiments, the UE may determine that each time offset value in the K time offset value is used to determine a feedback time unit for a corresponding PDSCH transmission group in the Q PDSCH transmission group.

For example, when it is assumed that the set of time offset values includes 5 time offset values, and there are 3 PDSCH transmission groups, then the first 3 time offset values in the 5 time offset values may be used for 3 PDSCH transmission groups, wherein each time offset value of the 3 time offset values is used to determine a feedback time unit for a corresponding PDSCH transmission group in the 3 PDSCH transmission groups.

In some other embodiments, K<Q. The UE may determine that the K time offset values are cyclically used to determine feedback time unit(s) for the Q PDSCH transmission groups.

FIG. 13 illustrates another exemplary method for determining feedback time units for multiple PDSCH transmission groups according to some embodiments of the present application.

In the example of FIG. 13, it is assumed that a UE receives a DCI scheduling 6 PDSCH transmissions, and the 6 PDSCH transmissions are included in three PDSCH transmission groups (e.g., PDSCH transmission group #1, PDSCH transmission group #2, and PDSCH transmission group #3). Moreover, it is also assumed that the set of time offset values indicated by the DCI or a higher layer signaling is {0, 1}. That is, K<Q. Then, the set of time offset values {0, 1} may be cyclically used to determine feedback time units for the 3 PDSCH transmission groups. That is, the UE may determine that the time offset value being 0 slot is used for PDSCH transmission group #1, the time offset value being 1 slot is used for PDSCH transmission group #2, and the time offset value being 0 slot is used for PDSCH transmission group #3.

Then, for PDSCH transmission group #1 which ends in DL slot #0, the UE may determine a feedback time unit to transmit the HARQ information for the PDSCH transmission group #1 is slot #0; for PDSCH transmission group #2 which ends in DL slot #1, the UE may determine a feedback time unit to transmit the HARQ information for the PDSCH transmission group #2 is slot #2; and for PDSCH transmission group #3 which ends in DL slot #2, the UE may determine a feedback time unit to transmit the HARQ information for the PDSCH transmission group #2 is slot #2.

After determining the feedback time unit for the PDSCH transmission group #G1, the UE may determine a PUCCH resource in the the feedback time unit to transmit the HARQ information based on the methods as specified in TS 38.213. For example, the methods may be illustrated in the following embodiments.

In some embodiments, for slot n+K1 where there is HARQ-ACK of an SPS PDSCH transmitted, if the UE is provided SPS-PUCCH-AN-List and transmits O_{UCI} UCI information bits that include only HARQ-ACK information bits in response to one or more SPS PDSCH receptions and SR, if any, the UE determines a PUCCH resource to be
a PUCCH resource provided by sps-PUCCH-AN-ResourceID obtained from the first entry in sps-PUCCH-AN-List if O_{UCI}≤2 including 1 or 2 HARQ-ACK information bits and a positive or negative SR on one SR transmission occasion if transmission of HARQ-ACK information and SR occurs simultaneously, or
a PUCCH resource provided by sps-PUCCH-AN-ResourceID obtained from the second entry in sps-PUCCH-AN-List, if provided, if 2<O_{UCI}≤N_{1,SPS} where N_{1,SPS} is either provided by maxPayloadSize obtained from the second entry in sps-PUCCH-AN-List or is otherwise equal to 1706, or
a PUCCH resource provided by sps-PUCCH-AN-ResourceID obtained from the third entry in sps-PUCCH-AN-List, if provided, if N_{1,SPS}<O_{UCI}≤N_{2,SPS} where N_{2,SPS} is either provided by maxPayloadSize obtained from the third entry in sps-PUCCH-AN-List or is otherwise equal to 1706, or
a PUCCH resource provided by sps-PUCCH-AN-ResourceID obtained from the fourth entry in sps-PUCCH-AN-List, if provided, if N_{2,SPS}<O_{UCI}≤N_{3,SPS} where N_{3,SPS} is equal to 1706.

In some other embodiments, for slot n+K1 where there is HARQ-ACK of an SPS PDSCH transmitted, if the UE is provided SPS-PUCCH-AN-List and transmits O_{UCI} UCI information bits that include not only HARQ-ACK information bits in response to one or more SPS PDSCH receptions and SR, if any, but also the HARQ-ACK information bits in response to the PDSCH with a corresponding PDCCH (or dynamic scheduling PDSCH), UE determines a PUCCH resource after determining a set of PUCCH resources for O_{UCI} HARQ-ACK information bits. A UE can be configured up for to four sets of PUCCH resources in a PUCCH-Config. A PUCCH resource set is provided by PUCCH-ResourceSet and is associated with a PUCCH resource set index provided by pucch-ResourceSetId, with a set of PUCCH resource indexes provided by resourceList that provides a set of pucch-ResourceId used in the PUCCH resource set, and with a maximum number of UCI information bits the UE can transmit using a PUCCH resource in the PUCCH resource set provided by maxPayloadSize. If the UE transmits O_{UCI} UCI information bits, that include HARQ-ACK information bits, the UE determines a PUCCH resource set to be
a first set of PUCCH resources with pucch-ResourceSetId=0 if O_{UCI}≤2 including 1 or 2 HARQ-ACK information bits and a positive or negative SR on one SR transmission occasion if transmission of HARQ-ACK information and SR occurs simultaneously, or
a second set of PUCCH resources with pucch-ResourceSetId=1, if provided by higher layers, if 2<O_{UCI}≤N₂ where N₂ is equal to maxPayloadSize if maxPayloadSize is provided for the PUCCH resource set with pucch-ResourceSetId=1; otherwise N₂ is equal to 1706, or
a third set of PUCCH resources with pucch-ResourceSetId=2, if provided by higher layers, if N₂<O_{UCI}≤N₃ where N₃ is equal to maxPayloadSize if maxPayloadSize is provided for the PUCCH resource set with pucch-ResourceSetId=2; otherwise N₃ is equal to 1706, or
a fourth set of PUCCH resources with pucch-ResourceSetId=3, if provided by higher layers, if N₃<O_{UCI}≤1706.

In some other embodiments, the PUCCH resource determination is based on a PUCCH resource indicator field, if present, in a last DCI format, among the DCI formats that have a value of a PDSCH-to-HARQ_feedback timing indicator field, if present, or a value of dl-DataToUL-ACK, or dl-DataToUL-ACK-r16, or dl-DataToUL-ACKForDCIFormat1_2, indicating a same slot for the PUCCH transmission, that the UE detects and for which the UE transmits corresponding HARQ-ACK information in the PUCCH where, for PUCCH resource determination.

Then, in step 405, the UE may transmit the HARQ information for the PDSCH transmission group #G1 in the determined feedback time unit. Actually, as stated above, for each PDSCH transmission group of the Q PDSCH transmission group, the UE may determine a corresponding feedback time unit for a corresponding PDSCH transmission group and transmit the HARQ information for the corresponding PDSCH transmission group in the corresponding feedback time unit.

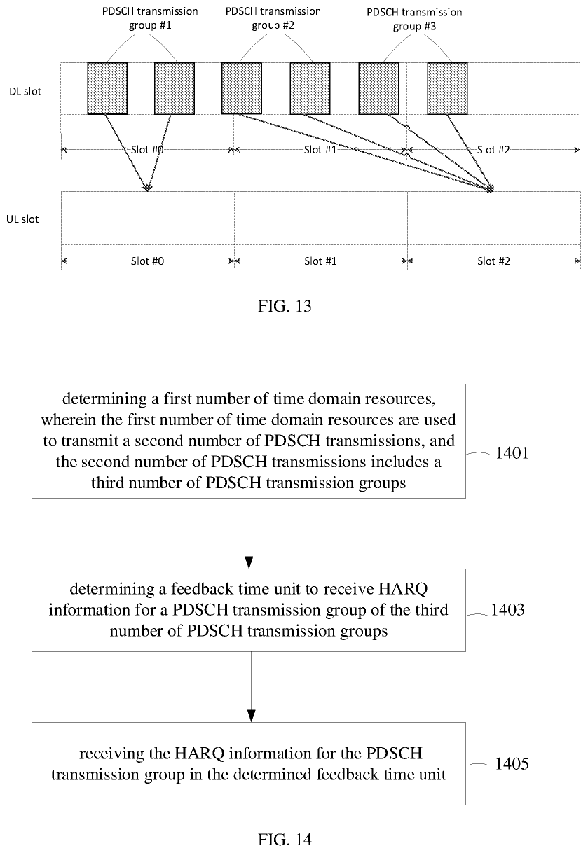

FIG. 14 is a flow chart illustrating an exemplary method for scheduling multiple PDSCH transmissions according to some embodiments of the present application. The method in FIG. 14 may be implemented by a BS (e.g., BS 101 as shown in FIG. 1).

In the exemplary method shown in FIG. 14, in step 1401, the BS may determine a first number (e.g., N) of time domain resources. The first number of time domain resources may be used to transmit a second number (e.g., M) of PDSCH transmissions.

In some embodiments of the present application, the N time domain resources may be determined based on a row (e.g., indexed with m+1, which is referred to as row #m+1) in a table (e.g., a TDRA table).

In an embodiment, the BS may configure the table to a UE (e.g., UE 102a or UE 102b) via a higher layer signaling (e.g., RRC signaling), for example, the table may be configured by the parameter “pdsch-TimeDomainAllocationListForMultiPDSCH-r17” as specified in 3GPP standard documents. In another embodiment, the table may be pre-defined (e.g., fixed in 3GPP standard documents). The table may include one or more rows (i.e., entries). Each of the one or more rows may indicate: multiple SLIVs or multiple start symbol and allocation length sets (each set may include a start symbol and an allocation length).

In such embodiments, the row #m+1 for determining N time domain resources may indicate multiple SLIVs or multiple start symbol and allocation length sets, wherein each SLIV or each start symbol and allocation length set may be used by the BS to determine a corresponding time domain resource.

Consequently, in such embodiments, the BS may determine N time domain resources, wherein N is equal to a number of SLIVs or a number of start symbol and allocation length sets indicated by the row #m+1. Each time domain resource of the N time domain resources is determined based on a corresponding SLIV of the multiple SLIVs or is determined based on a corresponding start symbol and allocation length set of multiple start symbol and allocation length sets indicated by the row #m+1.

In such embodiments, the BS may transmit DCI to indicate the row #m+1 in the table. For example, the DCI may include a TDRA field with a value “m” to indicate the row #m+1 in the table.

In some other embodiments of the present application, a first time domain resource of the N time domain resources may be determined based on a row (e.g., indexed with m+1, which is referred to as row #m+1) in a table (e.g., a TDRA table).

In an embodiment, the BS may configure the table to a UE (e.g., UE 102a or UE 102b) via a higher layer signaling (e.g., RRC signaling). In another embodiment, the table may be pre-defined (e.g., fixed in 3GPP standard documents). The table may include one or more rows (i.e., entries). Each of the one or more rows may indicate: a slot offset K₀ as specified in 3GPP standard documents, an SLIV or a start symbol and allocation length set (the set may include a start symbol and an allocation length), and a PDSCH mapping type to be assumed in the PDSCH transmission.

In such embodiments, the row #m+1 for determining the time domain resource may indicate an SLIV or a start symbol and allocation length set. The BS may determine a time domain resource based on the SLIV or start symbol and allocation length set indicated by the row #m+1. The determined time domain resource may be a first time domain resource in the N time domain resources.

Then, the BS may transmit DCI to indicate the row #m+1 in the table. For example, the DCI may include a TDRA field with a value “m” to indicate the row #m+1 in the table.

In such embodiments, the BS may use the same methods as those used by the UE in FIG. 4 to determine the remaining time domain resource. For example, the BS may determine the remaining time domain resources based on the following solutions.

### Solution 1

In solution 1, the BS may transmit an indication indicating the number “N” in the DCI or in a higher layer (e.g., a layer higher than a physical layer) signaling, e.g., RRC signaling. Specifically, the indication may indicate the number “N” by the following two alternatives.

In one alternative, the indication may directly indicate the number “N.”

In another alternative, a repetition number may be used as the number “N”. The indication transmitted by the BS may indicate whether the repetition number can be used as the number “N.” For example, the indication with value “1” may indicate that the repetition number is used as the number “N,” whereas the indication with value “0” may indicate that the repetition number is not used as the number “N,” and vice versa.

In solution 1, the N time domain resources are contiguous in the time domain. Accordingly, after determining the first time domain resource in the N time domain resources as stated above, the BS may determine the remaining time domain resources, wherein each remaining time domain resource may have the same time duration (e.g., including the same number of symbols) as the first time domain resource.

### Solution 2

In solution 2, the BS may transmit an indication indicating the number “N” in the DCI or in a higher layer (e.g., a layer higher than a physical layer) signaling, e.g., an RRC signaling. The indication may be the same as that in solution 1.

In solution 2, every two time domain resources of the time domain resources have a time gap between each other. In some embodiments, the BS may transmit a higher layer signaling indicating the time gap. In some other embodiments, the time gap may be a default value. The time gap may be a time duration or a number of time units. In an embodiment, the time unit may be a symbol, slot, etc. For example, the time gap may be a number of symbols.

Accordingly, after determining the first time domain resource in the N time domain resources as stated above, the BS may determine the remaining time domain resources based on the first time domain resource and the time gap. In some cases, the time gap may be used for determining the start point of each remaining time domain resource, for example, a start symbol of a next time domain resource may be equal to an end symbol of the preceding time domain resource plus the time gap. In solution 2, each remaining time domain resource may have the same time duration (e.g., including the same number of symbols) as the first time domain resource.

### Solution 3

In solution 3, the BS may transmit an indication indicating the number “N” in the DCI or in a higher layer (e.g., a layer higher than a physical layer) signaling, e.g., RRC signaling. The indication may be the same as that in solution 1.

In solution 3, the N time domain resource is in N contiguous slots, wherein each time domain resource is in a corresponding contiguous slot of the N contiguous slots, and a location of each time domain resource in the corresponding contiguous slot is the same. For example, the location of a time domain resource may refer to the start symbol and the time duration (e.g., including the same number of symbols) of the time domain resource.

Accordingly, after determining the first time domain resource which is in a slot, the BS may determine N-1 slots consecutive to the slot. Then, in each slot of the N-1 slots, the BS may determine a corresponding time domain resource. The corresponding time domain resource in each slot may have the same location (e.g., the start symbol and the time duration) as the first time domain resource.

### Solution 4

In solution 4, the BS may not indicate the number “N” to the UE. Instead, the BS may determine one or more time domain resources until a boundary of a periodicity of SPS or until a boundary of a slot, wherein the one or more time domain resources are contiguous in the time domain within the periodicity or the slot. Then, the one or more time domain resources determined by the UE may be the N time domain resources.

Specifically, after determining the first time domain resource which is in a periodicity of SPS or in a slot a as stated above, the BS may determine zero or more remaining time domain resources consecutive to the first time domain resource until a boundary of the periodicity of SPS or until a boundary of the slot, wherein each remaining time domain resource may have the same time duration (e.g., including the same number of symbols) as the first time domain resource. The determined remaining time domain resources and the first time domain resource are the N time domain resources.

### Solution 5

In solution 5, the BS may not indicate the number “N” to the UE. Instead, the BS may determine one or more time domain resources until a boundary of a periodicity of SPS or until a boundary of a slot, wherein every two time domain resources of the first number of time domain resources have a time gap between each other. Then, the one or more time domain resources determined by the UE may be the N time domain resources.

In some embodiments, the BS may receive a higher layer signaling indicating the time gap. In some other embodiments, the time gap may be a default value. The time gap may be a time duration or a number of time units. In an embodiment, the time unit may be a symbol, slot, etc. For example, the time gap may be a number of symbols.

Accordingly, after determining the first time domain resource which is in a periodicity of SRS or a slot as stated above, the UE may determine the remaining time domain resources based on the first time domain resource and the time gap until a boundary of the periodicity of SPS or until a boundary of the slot. In some cases, the time gap may be used for determining the start point of each remaining time domain resource, for example, a start symbol of a next time domain resource may be equal to an end symbol of the preceding time domain resource plus the time gap. In solution 5, each remaining time domain resource may have the same time duration (e.g., including the same number of symbols) as the first time domain resource.

As stated above, the N time domain resources may be used to transmit M PDSCH transmission.

According to some embodiments of the present application, M=N. That is, each of the N time domain resources is used to transmit a corresponding PDSCH transmission of N PDSCH transmissions. In such embodiments, each PDSCH transmission may include a different TB.

According to some other embodiments of the present application, the BS may determine M actual time domain resources based on the N time domain resources, wherein each actual time domain resource of the M actual time domain resources is used to transmit a corresponding PDSCH transmission of the N PDSCH transmissions. In such embodiments, the N time domain resources may also referred to as N nominal time domain resources.

In some embodiments, in order to determine the M actual time domain resources, the BS may first determine invalid symbol(s) for PDSCH transmission in each time domain resource of N time domain resources.

In an embodiment, the BS may transmit a parameter (e.g., a parameter tdd-UL-DL-ConfigurationCommon as specified in 3GPP standard documents or a parameter tdd-UL-DL-ConfigurationDedicated as specified in 3GPP standard documents) indicating which symbol(s) is uplink symbol(s) to the UE. In such embodiments, a symbol that is indicated as an uplink symbol is determined as an invalid symbol for PDSCH transmission by the BS.

Alternatively or additionally, the BS may transmit a higher layer parameter indicating invalid symbol(s) to the UE, and the invalid symbol(s) for PDSCH transmission in each time domain resources may be determined based on the higher layer parameter. For example, the BS may transmit a higher layer parameter invalidSymbolPattern as specified in 3GPP standard documents. The definitions and use cases for the invalidSymbolPattern in FIG. 4 may also be applied herein.

After determining the invalid symbol(s) for PDSCH transmission in each of the N time domain recourses, the BS may determine remaining symbol(s) other than the invalid symbol(s) in each of the N time domain resources to be valid symbol(s) for PDSCH transmission in each of the N time domain resources.

In the case that the valid symbol(s) in a time domain resource of the N time domain resources is greater than zero, the BS may determine that the time domain resource includes one or more actual time domain resources, wherein each actual time domain resources includes a group of consecutive valid symbols within a slot of the time domain resource. Consequently, the BS may determine M actual time domain resources based on the N time domain resources. The M actual time domain resources may be used to transmit M PDSCH transmissions, wherein each actual time domain resource may be used to transmit a corresponding PDSCH transmission.

In some embodiments, each actual time domain resource is used to transmit a different TB. In some other embodiments, the actual time domain resource(s) in a time domain resource is used to transmit repetition(s) of a same TB. In some other embodiments, the actual time domain resource(s) in a time domain resource is used to transmit a repetition(s) of a same TB, and a TB size of the same TB is determined based on the time domain resource or determined based on an actual time domain resource in the time domain resource.

According to some embodiments of the present application, in order to reduce feedback latency, the M PDSCH transmissions may be divided into Q PDSCH transmission groups.

In some embodiments of the present application, M=Q. That is, each PDSCH transmission group may include one PDSCH transmission of the M PDSCH transmissions.

In some other embodiments, the BS may use the same methods as those used by the UE in FIG. 4 to determine the Q PDSCH transmission groups. For example, the BS may determine the Q PDSCH transmission groups based on the following solutions.

### Solution I

In solution I, the BS may determine the number Q and indicate the number Q to the UE.

In some embodiments, the BS may transmit a higher layer signaling indicating the number Q.

In some other embodiments, the DCI transmitted by the BS may indicate a number of time offset values for determining feedback time units (which will be illustrated below), the BS may determine Q based on the number of time offset values, for example, the BS may determine Q to be equal to the number of time offset values.

After determining the number Q, in some embodiments, the BS may determine a number of PDSCH transmissions in each of first Q-1 PDSCH transmission groups in Q PDSCH transmission groups to be [M/Q], and a number of PDSCH transmissions in a last PDSCH transmission group in Q PDSCH transmission groups to be M-[M/Q]×(Q-1)).

In some other embodiments, the BS may determine a number of PDSCH transmissions in each of last Q-1 PDSCH transmission groups in Q PDSCH transmission groups to be [M/Q], and a number of PDSCH transmissions in a first PDSCH transmission group in Q PDSCH transmission groups to be M-[M/Q]×(Q-1)).

### Solution II

In solution II, the BS may transmit a higher layer signaling indicating a number of PDSCH transmission (e.g., P) included in each PDSCH transmission group. The BS may determine Q=[M/P].

In some embodiments, the BS may determine a number of PDSCH transmissions in each of first Q-1 PDSCH transmission groups in Q PDSCH transmission groups to be P, and a number of PDSCH transmissions in a last PDSCH transmission group in Q PDSCH transmission groups to be M-P×(Q-1)).

In some other embodiments, the BS may determine a number of PDSCH transmissions in each of last Q-1 PDSCH transmission groups in Q PDSCH transmission groups to be P, and a number of PDSCH transmissions in a first PDSCH transmission group in Q PDSCH transmission groups to be M-P×(Q-1)).

### Solution III

In solution III, the BS may determine the number Q and indicate it to the UE, which is the same as solution I. The BS may define M₁=mod(M, Q),

$${K}_{1} = ⌈ \frac{M}{Q} ⌉ , and {K}_{2} = ⌊ \frac{M}{Q} ⌋ .$$

In the case that M₁>0, the BS may determine that a PDSCH transmission group indexed with m includes PDSCH transmission(s) with index(es) m·K₁+k, k=0,1, . . . , K₁−1, wherein m=0,1, . . . , M₁−1; and determine that a PDSCH transmission group indexed with n includes PDSCH transmission(s) with index(es) M₁·K₁+(n-M₁)·K₂+k, k=0,1, . . . , K₂−1, wherein n=M₁, M₁+1, . . . , Q-1.

### Solution IV

In solution IV, the BS may transmit an indication indicating a set of PDSCH group division patterns in a higher layer signalling from the BS, wherein each PDSCH group division pattern may correspond to a number of PDSCH transmissions. The BS may determine the Q PDSCH transmission groups based on a PDSCH group division pattern in the set of PDSCH group division patterns.

For example, in the case that the set of PDSCH group division patterns includes a PDSCH group division pattern for the M PDSCH transmissions, BS may determine the Q PDSCH transmission groups based on the PDSCH group division pattern.

In the case that the set of PDSCH group division patterns does not include a PDSCH group division pattern for the M PDSCH transmissions, the BS may determine the Q PDSCH transmission groups based on a combination of PDSCH group division patterns included in the set of PDSCH group division patterns.

After determining the Q PDSCH transmission groups, in step 1403, for each PDSCH transmission group, the BS may determine a feedback time unit to receive the HARQ information for a corresponding PDSCH transmission group.

For simplicity, embodiments of FIG. 14 only takes a PDSCH transmission group (e.g., PDSCH transmission group #G1) as an example, the exemplary PDSCH transmission group #G1 in FIG. 14 may be any PDSCH transmission group in the Q PDSCH transmission groups, and the method for determining a feedback time unit to transmit the HARQ information for the PDSCH transmission group #G1 may also be used to determine a feedback time unit for other PDSCH transmission groups in the Q PDSCH transmission groups.

Specifically, in the case that time domain resource(s) for the PDSCH transmission group #G1 ends in a DL time unit n_{D}, the BS may determine the feedback time unit to receive the HARQ information for the PDSCH transmission group #G1 to be an UL time unit n+k, wherein n is a last UL time unit for PUCCH transmission that overlaps with n_{D}, and k is a time offset value.

In some embodiments, the time unit (e.g., the DL time unit, UL time unit, or the feedback time unit) as stated above may be a slot, a sub-slot, a symbol, or any other time unit.

In some embodiments, the time offset value may be in units of a slot, sub-slot, symbol, or any other time unit. For example, the time unit may be a slot and the time offset value may be a number of slots.

The time offset value k may be determined based on one of the following methods.

### Method 1

In method 1, the BS may determine k and indicate it to the UE by the DCI or a higher layer signalling.

Specifically, in some embodiments, the DCI transmitted by the BS may indicate a time offset value k in a set of time offset values. The set of time offset values may be configured by the BS via a higher layer signalling.

In some other embodiments, the BS may transmit a higher layer signalling indicating a time offset value k to the UE.

### Method 2

In method 2, the BS may indicate a set of time offset values to the UE via the DCI or via a higher layer signalling.

Specifically, in some embodiments, the DCI transmitted by the BS may indicate a set of time offset values in one or more sets of time offset values. The one or more sets of time offset values may be configured by the BS via a higher layer signalling.

In some other embodiments, the BS may transmit a higher layer signalling indicating a set of time offset values to the UE. The set of time offset values indicated by the DCI or the higher layer signalling may include K time offset values.

In such embodiments, the time offset value k may be a time offset value in the K time offset values which corresponds to the PDSCH transmission group #G1.

Specifically, in some embodiments, K=Q. That is, each time offset value in the set of time offset values may correspond to a PDSCH transmission group of the Q PDSCH transmission groups. In such embodiments, the BS may determine that each time offset value in the K time offset value is used to determine a feedback time unit for a corresponding PDSCH transmission group in the Q PDSCH transmission group.

In some other embodiments, K=Q. That is, each time offset value in the set of time offset values may correspond to a PDSCH transmission group of the Q PDSCH transmission groups. In such embodiments, the BS may determine that each time offset value in the K time offset value is used to determine a feedback time unit for a corresponding PDSCH transmission group in the Q PDSCH transmission group.

In some other embodiments, K>Q. The BS may determine that first Q time offset values in the K time offset values are used to determine feedback time unit(s) for the Q PDSCH transmission groups. That is, each time offset value in the first Q time offset values may correspond to a PDSCH transmission group of the Q PDSCH transmission groups. In such embodiments, the BS may determine that each time offset value in the K time offset value is used to determine a feedback time unit for a corresponding PDSCH transmission group in the Q PDSCH transmission group.

In some other embodiments, K<Q. The BS may determine that the K time offset values are cyclically used to determine feedback time unit(s) for the Q PDSCH transmission groups.

After determining the feedback time unit for the PDSCH transmission group #G1, the BS may determine a PUCCH resource in the the feedback time unit to receive the HARQ information based on the methods as specified in TS 38.213.

Then, in step 1405, the BS may receive the HARQ information for the PDSCH transmission group #G1 in the determined feedback time unit. Actually, as stated above, for each PDSCH transmission group of the Q PDSCH transmission group, the BS may determine a corresponding feedback time unit for a corresponding PDSCH transmission group and receive the HARQ information for the corresponding PDSCH transmission group in the corresponding feedback time unit.

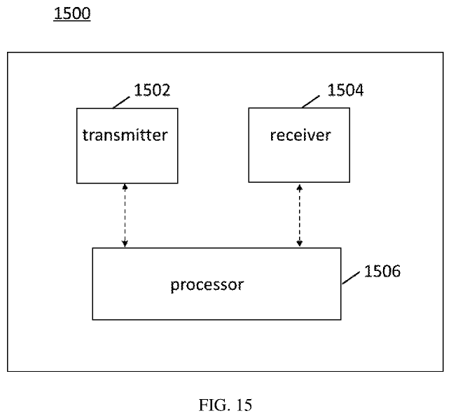

FIG. 15 illustrates a simplified block diagram of an exemplary apparatus for scheduling multiple PDSCH transmissions according to some embodiments of the present application. In some embodiments, the apparatus 1500 may be or include at least part of a UE (e.g., UE 102a or UE 102b in FIG. 1). In some other embodiments, the apparatus 1500 may be or include at least part of a BS (e.g., BS 101 in FIG. 1).

Referring to FIG. 15, the apparatus 1500 may include at least one transmitter 1502, at least one receiver 1504, and at least one processor 1506. The at least one transmitter 1502 is coupled to the at least one processor 1506, and the at least one receiver 1504 is coupled to the at least one processor 1506.

Although in this figure, elements such as the transmitter 1502, the receiver 1504, and the processor 1506 are illustrated in the singular, the plural is contemplated unless a limitation to the singular is explicitly stated. In some embodiments of the present application, the transmitter 1502 and the receiver 1504 may be combined to one device, such as a transceiver. In some embodiments of the present application, the apparatus 1500 may further include an input device, a memory, and/or other components. The transmitter 1502, the receiver 1504, and the processor 1506 may be configured to perform any of the methods described herein (e.g., the method described with respect to any of FIGS. 4-14).

According to some embodiments of the present application, the apparatus 1500 may be a UE, and the transmitter 1502, the receiver 1504, and the processor 1506 may be configured to perform operations of the any method as described with respect to FIGS. 4-13. For example, a processor 1506 may be configured to: determine a first number of time domain resources, wherein the first number of time domain resources are used to transmit a second number of PDSCH transmissions, and the second number of PDSCH transmissions includes a third number of PDSCH transmission groups; and determine a feedback time unit to transmit HARQ information for a PDSCH transmission group of the third number of PDSCH transmission groups. The transmitter 1502 may be configured to transmit the HARQ information for the PDSCH transmission group in the determined feedback time unit.

According to some embodiments of the present application, the apparatus 1500 may be a BS, and the transmitter 1502, the receiver 1504, and the processor 1506 may be configured to perform operations of the method as described with respect to FIG. 5-14. For example, a processor 1506 may be configured to: determine a first number of time domain resources, wherein the first number of time domain resources are used to transmit a second number of PDSCH transmissions, and the second number of PDSCH transmissions includes a third number of PDSCH transmission groups; and determine a feedback time unit to receive HARQ information for a PDSCH transmission group of the third number of PDSCH transmission groups. The receiver 1504 may be configured to receive the HARQ information for the PDSCH transmission group in the determined feedback time unit.

In some embodiments of the present application, the apparatus 1500 may further include at least one non-transitory computer-readable medium. In some embodiments of the present disclosure, the non-transitory computer-readable medium may have stored thereon computer-executable instructions to cause the processor 1506 to implement any of the methods as described above. For example, the computer-executable instructions, when executed, may cause the processor 1506 to interact with the transmitter 1502 and/or the receiver 1504, so as to perform operations of the methods, e.g., as described with respect to FIGS. 4-14.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for scheduling multiple PDSCH transmissions, including a processor and a memory. Computer programmable instructions for implementing a method for scheduling multiple PDSCH transmissions are stored in the memory, and the processor is configured to perform the computer programmable instructions to implement the method for scheduling multiple PDSCH transmissions. The method for scheduling multiple PDSCH transmissions may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for scheduling multiple PDSCH transmissions according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE), comprising:
at least one memory; and
at least one processor coupled with the at least one memory and configured to cause the UE to:
determine a first number of time domain resources, wherein the first number of time domain resources are used to transmit a second number of physical downlink shared channel (PDSCH) transmissions, and the second number of PDSCH transmissions includes a third number of PDSCH transmission groups;
determine a feedback time unit to transmit hybrid automatic repeat request (HARQ) information for a PDSCH transmission group of the third number of PDSCH transmission groups; and
transmit the HARQ information for the PDSCH transmission group in the determined feedback time unit.

2. The UE of claim 1, wherein the at least one processor is configured to cause the UE to receive downlink control information (DCI), the DCI includes a time domain resource allocation (TDRA) field which indicates a row in a table, and the row indicates one of: the first number of start and length indicators (SLIVs) or the first number of start symbol and allocation length sets; and
wherein each time domain resource of the first number of time domain resources is determined based on a corresponding SLIV of the first number of SLIVs or is determined based on a corresponding start symbol and allocation length set of the first number of start symbol and allocation length sets.

3. The UE of claim 1, wherein the first number is equal to the second number and each of the first number of time domain resources is used to transmit a corresponding PDSCH transmission of the second number of PDSCH transmissions.

4. The UE of claim 1, wherein the at least one processor is configured to cause the UE to determine the second number of actual time domain resources based on the first number of time domain resources, wherein each actual time domain resource of the second number of actual time domain resources is used to transmit a corresponding PDSCH transmission of the second number of PDSCH transmissions.

5. The UE of claim 4, wherein, to determine the second number of actual time domain resources, the at least one processor is configured to cause the UE to:
determine invalid symbol(s) for PDSCH transmission in each of the first number of time domain resources,
determine remaining symbol(s) other than the invalid symbol(s) in each of the first number of time domain resources to be valid symbol(s) for PDSCH transmission in each of the first number of time domain resources;
in the case that the valid symbol(s) in a time domain resource is greater than zero, determine the time domain resource includes one or more actual time domain resources, wherein each actual time domain resources includes a group of consecutive valid symbols within a slot of the time domain

6. The UE of claim 1, wherein the second number is equal to the third number and each PDSCH transmission group includes one PDSCH transmission.

7. The UE of claim 1, wherein the third number is configured by a higher layer signaling or determined based on a number of time offset values indicated by a DCI, and the at least one processor is configured to cause the UE to:
determine a number of PDSCH transmissions in each of first Q-1 PDSCH transmission groups in Q PDSCH transmission groups to be
$$⌊ \frac{M}{Q} ⌋ ,$$
and a number of PDSCH transmissions in a last PDSCH transmission group in Q PDSCH transmission groups to be M-[M/Q]×(Q-1)); or
determine a number of PDSCH transmissions in each of last Q-1 PDSCH transmission groups in Q PDSCH transmission groups to be
$$⌊ \frac{M}{Q} ⌋ ,$$
and a number of PDSCH transmissions in a first PDSCH transmission group in Q PDSCH transmission groups to be M-[M/Q]×(Q-1));
wherein M is the second number and Q is the third number.

8. The UE of claim 1, wherein the third number is configured by a higher layer signaling or determined based on a number of time offset values indicated by a DCI, and the at least one processor is configured to cause the UE to:
define M₁=mod(M, Q),
$${K}_{1} = ⌈ \frac{M}{Q} ⌉ , and {K}_{2} = ⌊ \frac{M}{Q} ⌋ ,$$
wherein M is the second number and Q is the third number;
in the case that M₁>0:
determine that a PDSCH transmission group indexed with m includes PDSCH transmission(s) with index(es) m·K₁+k, k=0,1, . . . , K₁−1, wherein m=0,1, . . . , M₁−1;
determine that a PDSCH transmission group indexed with n includes PDSCH transmission(s) with index(es) M₁·K₁+(n-M₁)·K₂+k, k=0,1, . . . , K₂−1, wherein n=M₁, M₁+1, . . . , Q-1.

9. The UE of claim 1,
wherein the at least one processor is configured to cause the UE to:
receive an indication indicating a set of PDSCH group division patterns, each PDSCH group division pattern corresponds to a corresponding number of PDSCH transmissions; and
determine the third number of PDSCH transmission groups based on a PDSCH group division pattern in the set of PDSCH group division patterns.

10. The UE of claim 1,
wherein the at least one processor is configured to cause the UE to receive a DCI indicating a time offset value in a set of time offset value configured by a higher layer signalling or receive a higher layer signalling indicating a time offset value; and
wherein time domain resource(s) for the PDSCH transmission group ends in a downlink (DL) time unit n_{D}, and the at least one processor is configured to cause the UE to determine the feedback time unit to transmit the HARQ information for the PDSCH transmission group to be an uplink (UL) time unit n +k, wherein n is a last UL time unit for PUCCH transmission that overlaps with n_{D}, and k is the time offset value indicated by the DCI or the higher layer signaling.

11. The UE of claim 1,
wherein the at least one processor is configured to cause the UE to receive a DCI indicating a set of time offset values in one or more sets of time offset values configured by a higher layer signalling or receive a higher layer signalling indicating a set of time offset values, wherein the set of time offset values includes K time offset values.

12. The UE of claim 11,
wherein K-Q, the at least one processor is further configured to cause the UE to determine that each time offset value in the K time offset value is used to determine a feedback time unit for a corresponding PDSCH transmission group in Q PDSCH transmission group, wherein Q is the third number; or
wherein K>Q, the at least one processor is configured to cause the UE to determine that first Q time offset values in the K time offset values are used to determine feedback time unit(s) for the Q PDSCH transmission groups; or
wherein K<Q, the at least one processor is configured to cause the UE to determine that the K time offset values are cyclically used to determine feedback time unit(s) for the Q PDSCH transmission groups.

13. The UE of claim 11,
wherein time domain resource(s) for the PDSCH transmission group ends in a downlink (DL) time unit n_{D}, and the at least one processor is configured to cause the UE to determine the feedback time unit to transmit the HARQ information for the PDSCH transmission group is an UL time unit n+k, wherein n is a last UL time unit for PUCCH transmission that overlaps with n_{D}, and k is a time offset value in the K time offset values which corresponds to the PDSCH transmission group.

14. A base station (BS), comprising:
at least one memory; and
at least one processor coupled with the at least one memory and configured to cause the base station to:
determine a first number of time domain resources, wherein the first number of time domain resources are used to transmit a second number of physical downlink shared channel (PDSCH) transmissions, and the second number of PDSCH transmissions includes a third number of PDSCH transmission groups;
determine a feedback time unit to receive hybrid automatic repeat request (HARQ) information for a PDSCH transmission group of the third number of PDSCH transmission groups; and
receive the HARQ information for the PDSCH transmission group in the determined feedback time unit.

15. A method performed by a user equipment (UE), the method comprising:
determining a first number of time domain resources, wherein the first number of time domain resources are used to transmit a second number of physical downlink shared channel (PDSCH) transmissions, and the second number of PDSCH transmissions includes a third number of PDSCH transmission groups;
determining a feedback time unit to transmit hybrid automatic repeat request (HARQ) information for a PDSCH transmission group of the third number of PDSCH transmission groups; and
transmitting the HARQ information for the PDSCH transmission group in the determined feedback time unit.

16. A processor for wireless communication, comprising:
at least one controller coupled with at least one memory and configured to cause the processor to:
determine a first number of time domain resources, wherein the first number of time domain resources are used to transmit a second number of physical downlink shared channel (PDSCH) transmissions, and the second number of PDSCH transmissions includes a third number of PDSCH transmission groups;
determine a feedback time unit to transmit hybrid automatic repeat request (HARQ) information for a PDSCH transmission group of the third number of PDSCH transmission groups; and
transmit the HARQ information for the PDSCH transmission group in the determined feedback time unit.

17. The processor of claim 16, wherein the at least one controller is configured to cause the processor to receive downlink control information (DCI), the DCI includes a time domain resource allocation (TDRA) field which indicates a row in a table, and the row indicates one of: the first number of start and length indicators (SLIVs) or the first number of start symbol and allocation length sets; and
wherein each time domain resource of the first number of time domain resources is determined based on a corresponding SLIV of the first number of SLIVs or is determined based on a corresponding start symbol and allocation length set of the first number of start symbol and allocation length sets.

18. The processor of claim 16, wherein the first number is equal to the second number and each of the first number of time domain resources is used to transmit a corresponding PDSCH transmission of the second number of PDSCH transmissions.

19. The processor of claim 16, wherein the at least one controller is configured to cause the processor to determine the second number of actual time domain resources based on the first number of time domain resources, wherein each actual time domain resource of the second number of actual time domain resources is used to transmit a corresponding PDSCH transmission of the second number of PDSCH transmissions.

20. The processor of claim 19, wherein, to determine the second number of actual time domain resources, the at least one controller is configured to cause the processor to:
determine invalid symbol(s) for PDSCH transmission in each of the first number of time domain resources,
determine remaining symbol(s) other than the invalid symbol(s) in each of the first number of time domain resources to be valid symbol(s) for PDSCH transmission in each of the first number of time domain resources;
in the case that the valid symbol(s) in a time domain resource is greater than zero, determine the time domain resource includes one or more actual time domain resources, wherein each actual time domain resources includes a group of consecutive valid symbols within a slot of the time domain resource.
